(19) United States
(12) Patent Application Publication
(10) Pub. No.: US 2021/0326886 A1
(43) Pub. Date: Oct. 21, 2021

(54) BLOCKCHAIN-BASED RESOURCE TRANSACTION METHODS, APPARATUSES, AND SYSTEMS

(71) Applicant: ALIPAY (HANGZHOU) INFORMATION TECHNOLOGY CO., LTD., Hangzhou (CN)

(72) Inventors: Diaolong Tang, Hangzhou (CN); Shanlu Sun, Hangzhou (CN); Xiao Wu, Hangzhou (CN); Tiantian Li, Hangzhou (CN); Ningning Zhao, Hangzhou (CN); Ting Hu, Hangzhou (CN); Jin Wu, Hangzhou (CN)

(73) Assignee: ALIPAY (HANGZHOU) INFORMATION TECHNOLOGY CO., LTD., Hangzhou (CN)

(21) Appl. No.: 17/359,454

(22) Filed: Jun. 25, 2021

(30) Foreign Application Priority Data
Sep. 21, 2020 (CN) 202010997277.1

(51) Int. Cl. G06Q 20/40

(52) U.S. Cl. CPC G06Q 20/4016

(57) ABSTRACT

Disclosed herein are methods, systems, and apparatus, including computer programs encoded on computer storage media, for blockchain-based resource transaction. One of the method includes receiving a resource transaction request by a first resource trading platform connected to a blockchain network from a first user to execute a first resource transaction related to risk assessment. Authorization information of a risk assessment card of the first user is queried from an authorization management platform that is connected to the blockchain network. If it is determined that the first resource trading platform is authorized to obtain risk assessment data of the first user, the risk assessment data of the first user is obtained from a blockchain node of the blockchain network. It is determined, based on the risk assessment data of the first user, whether to execute the first resource transaction for the first user.

### CROSS-REFERENCE TO RELATED APPLICATIONS

This application claims priority to Chinese Patent Application No. 202010997277.1, filed on Sep. 21, 2020, which is hereby incorporated by reference in its entirety.

### TECHNICAL FIELD

The present specification relates to the field of blockchain technologies, and in particular, to blockchain-based resource transaction methods, apparatuses, and systems.

### BACKGROUND

Blockchain is a new application mode of computer technologies such as distributed data storage, point-to-point transmission, consensus algorithm, and encryption algorithm. Blockchain is an important concept of bitcoin, and its essence is a decentralized database. In a blockchain system, data blocks are sequentially connected in chronological order to form a chained data structure, and a distributed ledger that cannot be tampered with or forged is ensured by using cryptography. The blockchain features decentralization, tamper-resistance of information, autonomy, independence, etc., and therefore has attracted increasing attention and applications.

### SUMMARY

According to an aspect, one or more embodiments of the present specification provide a blockchain-based resource transaction method, applied to a first resource trading platform connected to a blockchain, where the method includes the following: receiving a resource transaction request that is sent by a first user and that includes digital identity information of the first user, where the resource transaction request is used to request to execute a first resource transaction related to risk assessment; querying, based on the digital identity information, relevant authorization information of a risk assessment card corresponding to the first user from an authorization management platform that is connected to the blockchain, where the risk assessment card is used for a resource trading platform to obtain risk assessment data corresponding to the first user; determining, based on the relevant authorization information, whether the first resource trading platform is authorized to obtain the risk assessment data of the first user, and if yes, obtaining the risk assessment data of the first user from a blockchain node, where the blockchain node is used to store risk assessment data corresponding to each user; and determining, based on the risk assessment data of the first user, whether to execute the first resource transaction for the first user.

According to another aspect, one or more embodiments of the present specification provide a blockchain-based resource transaction method, applied to an authorization management platform connected to a blockchain, where the method includes the following: obtaining risk assessment data of a first user, and obtaining digital identity information of the first user; uploading the digital identity information of the first user and the risk assessment data to a blockchain node, where the blockchain node is used to store the digital identity information of the first user and the risk assessment data in association, and send a blockchain storage certificate corresponding to the risk assessment data to the authorization management platform; and generating a risk assessment card corresponding to the first user based on the digital identity information of the first user and the blockchain storage certificate sent by the blockchain node, where the risk assessment card is used for a resource trading platform connected to the blockchain to obtain the risk assessment data from the blockchain node, and execute a related resource transaction for the first user based on the risk assessment data.

According to still another aspect, one or more embodiments of the present specification provide a blockchain-based resource transaction apparatus, applied to a first resource trading platform connected to a blockchain, where the apparatus includes the following: a first receiving module, configured to receive a resource transaction request that is sent by a first user and that includes digital identity information of the first user, where the resource transaction request is used to request to execute a first resource transaction related to risk assessment; a querying module, configured to query, based on the digital identity information, relevant authorization information of a risk assessment card corresponding to the first user from an authorization management platform that is connected to the blockchain, where the risk assessment card is used for a resource trading platform to obtain risk assessment data corresponding to the first user; a first determining module, configured to determine, based on the relevant authorization information, whether the first resource trading platform is authorized to obtain the risk assessment data of the first user, and if yes, obtain the risk assessment data of the first user from a blockchain node, where the blockchain node is used to store risk assessment data corresponding to each user; and a second determining module, configured to determine, based on the risk assessment data of the first user, whether to execute the first resource transaction for the first user.

According to still another aspect, one or more embodiments of the present specification provide a blockchain-based resource transaction apparatus, applied to an authorization management platform connected to a blockchain, where the apparatus includes the following: a first acquisition module, configured to obtain risk assessment data of a first user, and obtain digital identity information of the first user; a blockchain uploading module, configured to upload the digital identity information of the first user and the risk assessment data to a blockchain node, where the blockchain node is used to store the digital identity information of the first user and the risk assessment data in association, and send a blockchain storage certificate corresponding to the risk assessment data to the authorization management platform; and a generating module, configured to generate a risk assessment card corresponding to the first user based on the digital identity information of the first user and the blockchain storage certificate sent by the blockchain node, where the risk assessment card is used for a resource trading platform connected to the blockchain to obtain the risk assessment data from the blockchain node, and execute a related resource transaction for the first user based on the risk assessment data.

According to still another aspect, one or more embodiments of the present specification provide a blockchain-based resource transaction system, including the following: a first resource trading platform connected to a blockchain, configured to receive a resource transaction request that is sent by a first user and that includes digital identity information of the first user, where the resource transaction request is used to request to execute a first resource transaction related to risk assessment; send a request for querying relevant authorization information of a risk assessment card corresponding to the first user to an authorization management platform that is connected to the blockchain, where the risk assessment card is used to authorize each resource trading platform to obtain risk assessment data corresponding to the first user; determine, based on the relevant authorization information, whether the first resource trading platform is authorized to obtain the risk assessment data of the first user, and if yes, obtain the risk assessment data of the first user from a blockchain node; and determine, based on the risk assessment data of the first user, whether to execute the first resource transaction for the first user. The authorization management platform is configured to store relevant authorization information of a risk assessment card corresponding to each user, and query the relevant authorization information of the risk assessment card corresponding to the first user based on the request for querying the relevant authorization information of the risk assessment card corresponding to the first user, where the request is sent by the first resource trading platform. The blockchain node is configured to store risk assessment data corresponding to each user; and send the risk assessment data to the first resource trading platform based on a request for obtaining the risk assessment data, where the request is sent by the first resource trading platform.

According to still another aspect, one or more embodiments of the present specification provide a blockchain-based resource transaction device, including a processor and a memory electrically connected to the processor, where the memory stores a computer program, and the processor is configured to invoke and execute the computer program from the memory to implement the blockchain-based resource transaction method according to any one of the previous aspects.

According to still another aspect, one or more embodiments of the present application provide a storage medium, configured to store a computer program, where the computer program can be executed by a processor to implement the blockchain-based resource transaction method according to any one of the previous aspects.

### BRIEF DESCRIPTION OF DRAWINGS

To describe the technical solutions in one or more embodiments of the present specification or the existing technology more clearly, the following briefly introduces the accompanying drawings needed for describing the embodiments or the existing technology. Clearly, the accompanying drawings in the following description are merely one or more embodiments of the present specification, and a person of ordinary skill in the art can obtain other drawings based on the accompanying drawings without creative efforts.

FIG. 1 is a schematic diagram illustrating an example of an application scenario of a blockchain-based resource transaction method, according to some embodiments of the present specification;

FIG. 2 is a schematic flowchart illustrating an example a blockchain-based resource transaction method, according to some embodiments of the present specification;

FIG. 3 is a schematic flowchart illustrating an example of a blockchain-based resource transaction method, according to other embodiments of the present specification;

FIG. 4 is a schematic flowchart illustrating an example a blockchain-based resource transaction method, according to still other embodiments of the present specification;

FIG. 5 is a schematic flowchart illustrating an example a blockchain-based resource transaction method, according to still other embodiments of the present specification;

FIG. 6(a) to FIG. 6(e) are schematic interface diagrams for generating a risk assessment card in a blockchain-based resource transaction method, according to some embodiments of the present specification;

FIG. 7 is a schematic flowchart illustrating an example of a blockchain-based resource transaction method, according to still other embodiments of the present specification;

FIG. 8 is a schematic block diagram illustrating an example of a blockchain-based resource transaction apparatus, according to some embodiments of the present specification;

FIG. 9 is a schematic block diagram illustrating an example of a blockchain-based resource transaction apparatus, according to other embodiments of the present specification;

FIG. 10 is a schematic block diagram illustrating an example of a blockchain-based resource transaction system, according to some embodiments of the present specification; and

FIG. 11 is a schematic block diagram illustrating an example of a blockchain-based resource transaction device, according to some embodiments of the present specification.

### DESCRIPTION OF EMBODIMENTS

One or more embodiments of the present specification provide blockchain-based resource transaction methods, apparatuses, and systems, so as to solve the problems of low resource transaction efficiency and poor appropriateness management of resource traders caused by independence of a plurality of resource trading platforms.

To enable a person skilled in the art to better understand the technical solutions in one or more embodiments of the present specification, the following clearly and fully describes the technical solutions in one or more embodiments of the present specification with reference to the accompanying drawings in one or more embodiments of the present specification. Clearly, the described embodiments are merely some rather than all of the embodiments of the present specification. Based on one or more embodiments of the present specification, all other embodiments obtained by a person of ordinary skill in the art without creative efforts shall fall within the protection scope of the one or more embodiments of the present specification.

Generally, risk assessment needs to be performed when a user requests a financial service through a financial institution. For example, when the user purchases a wealth management product, risk assessment needs to be performed on the user. The so-called risk assessment means assessing risk tolerance of the user, so that the financial institution can provide the user with a product or service that matches the risk tolerance based on a result of the risk assessment on the user. When the user invests in a financial institution, the corresponding financial institution stores information about the user, for example, risk assessment result information and basic information such as an age, an identity card, a family situation, an income, etc. To ensure security and privacy of user information, more financial institutions have begun to introduce blockchain to store user profile information. As time goes by, some wealth management habits, a household income, and other information of the user may change. Therefore, some financial institutions require the user to be subject to risk assessment again at regular intervals, or the user actively initiates risk assessment again. In either scenario, when risk assessment is performed on the user again, new risk assessment information is generated. In this case, the risk assessment information of the user previously stored in the blockchain needs to be updated, and it is necessary to ensure that a service processing platform can accurately and effectively obtain the updated risk assessment information, and can adjust the product or service provided for the user in a timely manner.

Based on these needs, embodiments of the present specification provide blockchain-based resource transaction methods, apparatuses, and systems.

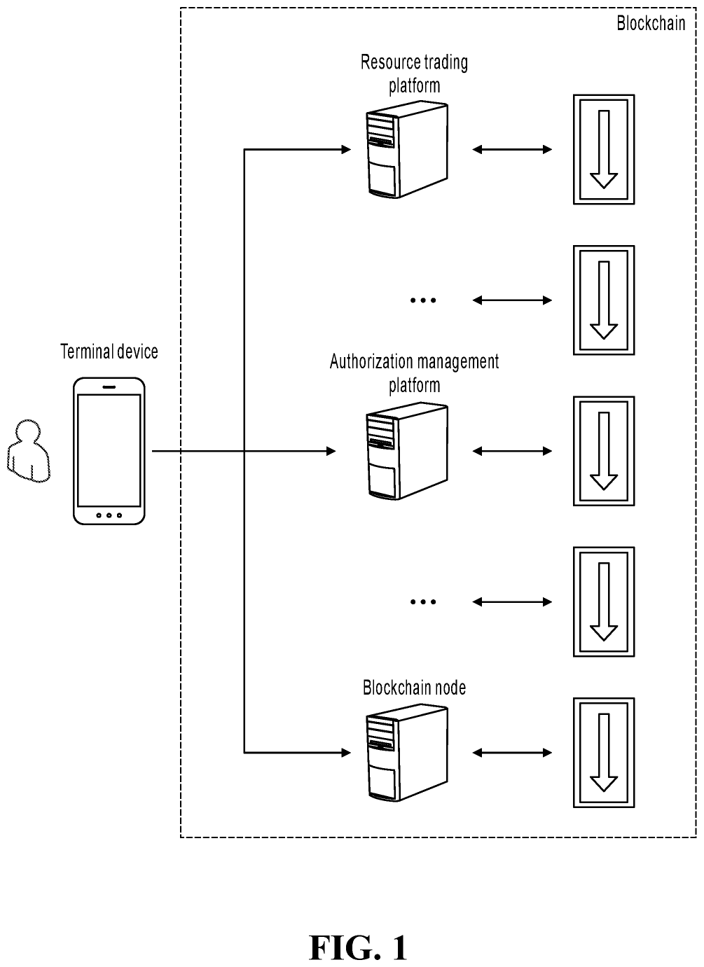

FIG. 1 is a schematic diagram illustrating an example of an application scenario of a blockchain-based resource transaction method, according to some embodiments of the present specification. As shown in FIG. 1, the application scenario includes a terminal device, a resource trading platform, an authorization management platform, and a blockchain node. The terminal device can be a device such as a mobile phone, a tablet computer, or a computer. A client device with a resource transaction function is installed on the terminal device. The client device can be an independent application (APP) installed on the terminal device, an applet embedded into some independent applications, or a web page, etc. Both the resource trading platform and the authorization management platform are connected to the blockchain. One or more resource trading platforms can be connected to the blockchain, and data can be shared among the resource trading platforms based on the blockchain. In the application scenario shown in FIG. 1, only one resource trading platform is shown as an example. The quantity does not limit a quantity of resource trading platforms connected to the blockchain in the actual scenario. The ellipsis “ . . . ” in the figure means that more resource trading platforms or other devices can be further connected to the blockchain. In the application scenario, the blockchain can be a consortium blockchain, and the resource trading platform, the authorization management platform, and the blockchain node that are connected to the blockchain are consortium members of the consortium blockchain.

Specifically, the resource trading platform connected to the blockchain stores risk assessment data corresponding to the user, including risk profile data, a risk assessment record, etc. The risk profile data can include user identity information (such as the user's age, gender, income range, family situation, and risk assessment questionnaire record), user behavior information (such as payment data, transfer data, transaction data, etc.) generated through the resource trading platform, etc. The risk assessment record includes, for example, a risk assessment result, etc. The authorization management platform is used to provide an authorization service for the resource trading platform to obtain the risk assessment data of the user from the blockchain node, and to store authorization information corresponding to the resource trading platform that is authorized to obtain the risk assessment data of the user from the blockchain node. The blockchain node is used to store the risk assessment data uploaded by the user through the authorization management platform. Through interaction between the consortium members of the blockchain, when the user executes a resource transaction through any resource trading platform, the user does not need to repeatedly input the risk profile data or repeat the risk assessment, thereby implementing efficiency of resource transaction and improving an effect of appropriateness management of a resource investor.

The risk assessment record stored in the resource trading platform can be obtained by the user by operating the client device on the terminal device when conducting a service related to the risk assessment, such as filling in a risk assessment questionnaire. The client device uploads the risk assessment questionnaire information filled in by the user to the resource trading platform, and the resource trading platform generates a corresponding risk assessment record based on the risk assessment questionnaire information of the user. The risk assessment record can include a risk assessment result, serial number information corresponding to the risk assessment record, user identification information, account information, etc.

The authorization management platform obtains the risk assessment data of the user from the resource trading platform and obtains the digital identity information of the user, where the digital identity information can be, for example, a decentralized identity (DID), and uploads the digital identity information and risk assessment data of the user to the blockchain node, so as to store the risk assessment data corresponding to the user in the blockchain node. Based on the previous description, after receiving the resource transaction request sent by the user, the resource trading platform can obtain the risk assessment data of the user from the blockchain node based on the digital identity information of the user, and determine, based on the risk assessment data of the user, whether to execute the resource transaction for the user. Before obtaining the risk assessment data of the user from the blockchain node, the resource trading platform needs to confirm, through an authorization management center, whether the resource trading platform has a permission to obtain the risk assessment data. The following describes in detail a blockchain-based resource transaction method provided in some embodiments of the present specification.

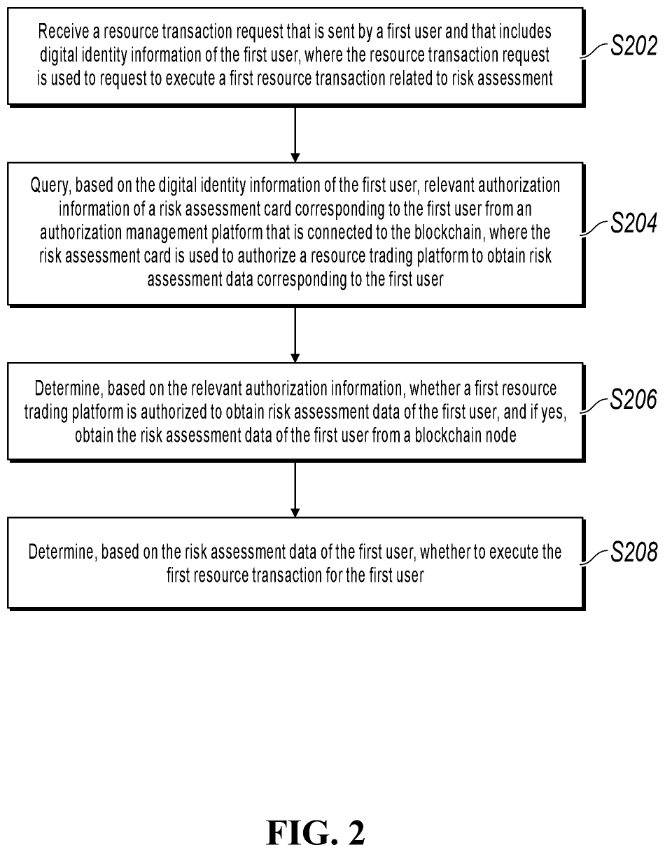

FIG. 2 is a schematic flowchart illustrating an example of a blockchain-based resource transaction method, according to some embodiments of the present specification. As shown in FIG. 2, the method is applied to a first resource trading platform connected to a blockchain. The first resource trading platform can be any one of a plurality of resource trading platforms connected to the blockchain. The method includes the following steps:

S202: Receive a resource transaction request that is sent by a first user and that includes digital identity information of the first user, where the resource transaction request is used to request to execute a first resource transaction related to risk assessment.

The digital identity information of the first user can be a decentralized identity (DID), that is, a distributed digital identifier, which can be created in advance based on the blockchain, and features tamper-resistance upon creation once.

S204: Query, based on the digital identity information of the first user, relevant authorization information of a risk assessment card corresponding to the first user from an authorization management platform that is connected to the blockchain, where the risk assessment card is used for a resource trading platform to obtain risk assessment data corresponding to the first user.

The risk assessment card can be understood as a blockchain storage certificate issued to the user by the blockchain. After the user authorizes, through the authorization management platform, the upload of the risk assessment data of the user to the blockchain, the blockchain issues the blockchain storage certificate corresponding to the risk assessment data of the user. The authorization management platform generates a risk assessment card corresponding to the user based on the blockchain storage certificate. The risk assessment card can be used for any resource trading platform connected to the blockchain to obtain the risk assessment data of the user from the blockchain node.

The risk assessment data can include risk profile data, a risk assessment record, etc. of the user. The risk profile data can include user identity information (such as the user's age, gender, income range, family situation, and risk assessment questionnaire record), user behavior information (such as payment data, transfer data, transaction data, etc.) generated through the resource trading platform, etc. The risk assessment record includes, for example, a risk assessment result, etc.

The relevant authorization information of the risk assessment card includes authorization information corresponding to the resource trading platform authorized by the risk assessment card. The digital identity information of each user is stored in association with the relevant authorization information of the risk assessment card in the authorization management platform.

S206: Determine, based on the relevant authorization information, whether a first resource trading platform is authorized to obtain risk assessment data of the first user, and if yes, obtain the risk assessment data of the first user from a blockchain node.

The blockchain node is used to store risk assessment data corresponding to each user. The digital identity information of each user is stored in association with the corresponding risk assessment data in the blockchain node. Optionally, if the relevant authorization information of the risk assessment card includes authorization information corresponding to the first resource trading platform, it can be determined that the first resource trading platform is authorized to obtain the risk assessment data of the first user.

S208: Determine, based on the risk assessment data of the first user, whether to execute the first resource transaction for the first user.

In the present step, a risk tolerance level corresponding to the first user can be determined based on the risk assessment data of the first user. If the risk assessment data includes only the risk profile data of the first user, risk assessment can be performed based on the risk profile data to determine the risk tolerance level corresponding to the first user. If the risk assessment data includes the risk assessment record of the first user, the risk tolerance level corresponding to the first user can be determined based on the risk assessment record.

Corresponding transaction risk levels can be predetermined for various resource transactions, and the transaction risk levels can be used to represent transaction level requirements corresponding to the resource transactions. In other words, resource transactions with different transaction risk levels correspond to different transaction level requirements. If the risk tolerance level corresponding to the first user satisfies the transaction level requirement corresponding to the first resource transaction, the first resource transaction is executed for the user. Otherwise, it can be determined that the risk tolerance level corresponding to the first user is relatively low with respect to the first resource transaction. In this case, the first resource transaction is not executed for the user.

The transaction risk level corresponding to the resource transaction can be pre-stored in the blockchain node. Specifically, the blockchain node stores the transaction identification information (such as a resource transaction name, etc.) and a transaction risk level of each resource transaction in association. In this way, when obtaining the risk profile data of the first user from the blockchain node, the first resource trading platform can send the digital identity information of the first user and the transaction identification information of the first resource transaction together to the blockchain node, so that the blockchain node returns the risk profile data of the first user to the first resource trading platform based on the digital identity information of the first user, and queries the transaction risk level of the first resource transaction based on the transaction identification information of the first resource transaction, and returns the transaction risk level of the first resource transaction to the first resource trading platform.

According to the technical solutions in one or more embodiments of the present specification, when receiving the resource transaction request sent by the first user, the first resource trading platform queries the relevant authorization information of the risk assessment card corresponding to the first user from the authorization management platform that is connected to the blockchain. The risk assessment card is used for the resource trading platform to obtain the risk assessment data corresponding to the first user. In addition, the first resource trading platform determines, based on the relevant authorization information, whether the first resource trading platform is authorized to obtain the risk assessment data of the first user, and if yes, obtains the risk assessment data of the first user from the blockchain node, and further determines, based on the risk assessment data, whether to execute the resource transaction for the first user. It can be determined that the first resource trading platform obtains the risk assessment data corresponding to the first user from the blockchain node through the risk assessment card, so that when the first user executes the resource transaction through the first resource trading platform, there is no need to repeat the risk assessment, and the user only needs to obtain the risk assessment data of the user from the blockchain node to complete the risk assessment operation in the first resource transaction, thereby simplifying the resource transaction process and improving the processing efficiency of resource transaction. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

In some embodiments, the authorization management platform stores a verifiable statement of the risk assessment card corresponding to each user, and content data of the verifiable statement includes authorization information corresponding to an authorized resource trading platform. Based on the previous description, in S204, when the relevant authorization information of the risk assessment card corresponding to the first user is queried from the authorization management platform connected to the blockchain, the verifiable statement of the risk assessment card corresponding to the first user can be queried from the authorization management platform. Therefore, the relevant authorization information of the risk assessment card corresponding to the first user is queried based on the content data of the verifiable statement. Further, when S206 is performed, it can be determined whether the content data of the verifiable statement includes first authorization information corresponding to the first resource trading platform. If yes, it is determined that the first resource trading platform is authorized to obtain the risk assessment data of the first user. If no, it is determined that the first resource trading platform is not authorized to obtain the risk assessment data of the first user.

In some embodiments, if the content data of the verifiable statement does not include the first authorization information corresponding to the first resource trading platform, it is determined that the first resource trading platform is not authorized to obtain the risk assessment data of the first user. In this case, the first user can be provided with an authorization portal for authorizing the first resource trading platform to obtain the risk assessment data of the first user. The authorization portal can be displayed on the client interface corresponding to the first resource trading platform. The first user can perform an authorization operation based on the authorization portal. When receiving an authorization operation performed by the first user through the authorization portal, the first resource trading platform determines, based on the authorization operation, that the first resource trading platform is authorized to obtain the risk assessment data of the first user. Further, the first resource trading platform can obtain the risk assessment data of the first user from the blockchain node.

In these embodiments, after the first user performs the authorization operation through the authorization portal, it is equivalent to that the first user authorizes the first resource trading platform to obtain the risk assessment data of the first user from the blockchain node. Therefore, the first resource trading platform can generate and send its corresponding first authorization information to the authorization management platform, so that the authorization management platform updates the relevant authorization information of the risk assessment card corresponding to the first user based on the first authorization information. In this way, when the first resource trading platform receives the resource transaction request sent by the first user again, the relevant authorization information of the risk assessment card corresponding to the first user obtained from the authorization management platform includes the first authorization information corresponding to the first resource trading platform, or the content data of the verifiable statement of the risk assessment card corresponding to the first user obtained from the authorization management platform includes the first authorization information, so that the first resource trading platform is authorized, based on the first authorization information, to obtain the risk assessment data of the first user from the blockchain node.

As mentioned in the previous embodiments, the risk assessment data of the first user can include the risk profile data, the risk assessment record, etc. of the first user. Therefore, when S208 is performed, the methods for determining whether to execute the first resource transaction for the first user are different based on the different content included in the risk assessment data obtained from the blockchain node. Detailed descriptions are as follows.

In some embodiments, the risk assessment data of the first user includes the first risk assessment record of the first user, and the first risk assessment record is used to record the first risk tolerance level obtained after risk assessment is performed on the first user. The risk assessment is performed on the first user based on the risk profile data of the first user. The risk tolerance level can be represented in different ways. For example, different symbols can be used to represent different levels. For example, C1, C2, C3, C4, and C5 sequentially represent risk tolerance levels in ascending order. Alternatively, the risk tolerance level can be represented by specific categories, such as robust, conservative, etc.

Certainly, in addition to recording the risk tolerance level corresponding to the first user, the first risk assessment record can further record one or more types of the following information: user identification information of the first user on the resource trading platform, login account information of the first user for the risk assessment, risk assessment number information of the first user for the risk assessment, time information of the first user for the risk assessment, identification information of a risk assessment platform that performs risk assessment on the first user, etc. Certainly, in addition to the content listed above, the content included in the risk assessment record can further include other content. The previous description lists only examples of some types of possible information, and does not constitute a limitation on the embodiments of the present specification.

In these embodiments, the risk assessment record included in the risk assessment data stored in the blockchain node can be obtained after risk assessment is performed based on the risk profile data of the user in the process of generating the risk assessment card by the authorization management platform, and is uploaded together with the risk profile data of the user to the blockchain node for storage. Alternatively, the risk assessment record can be obtained by the blockchain node in advance from a resource trading platform that is connected to the blockchain and stores the risk assessment record of the user.

Therefore, when the risk assessment data of the first user includes the first risk assessment record of the first user, it can be determined, based on the first risk assessment record, whether the first risk tolerance level corresponding to the first user satisfies the transaction level requirement corresponding to the first resource transaction, and a determining result is fed back to the first user, that is, the determining result is displayed on the client interface corresponding to the first resource trading platform.

If the first risk tolerance level corresponding to the first user satisfies the transaction level requirement corresponding to the first resource transaction, the first resource transaction is executed for the first user, and a resource transaction result corresponding to the first resource transaction is fed back to the first user, that is, the resource transaction result is displayed on the client interface corresponding to the first resource trading platform.

If the first risk tolerance level corresponding to the first user does not satisfy the transaction level requirement corresponding to the first resource transaction, the first user can trigger the first resource trading platform through the client device to re-assess the risk tolerance level of the first user. Specifically, when the assessment request of the first user for re-assessing the risk tolerance level is received, the risk profile data included in the risk assessment data of the first user can be displayed on the client interface, and the first user can modify the displayed risk profile data on the client interface. When receiving the updating operation (that is, the modification operation) of the first user for the risk profile data, the first resource trading platform updates the risk profile data of the first user based on the updating operation; re-assesses the risk tolerance level of the first user based on the updated risk profile data to obtain a second risk tolerance level corresponding to the first user; and further determines, based on the second risk tolerance level, whether to execute the first resource transaction for the first user.

In these embodiments, after the risk tolerance level of the first user is re-assessed to obtain the second risk tolerance level corresponding to the first user, the first risk assessment record corresponding to the first user stored in the blockchain node can be further updated based on the second risk tolerance level. Specifically, the digital identity information of the first user and the second risk tolerance level can be uploaded to the blockchain node. The blockchain node identifies the risk assessment data of the first user based on the digital identity information of the first user, and then updates the risk assessment data of the first user, or updates the first risk assessment record corresponding to the first user based on the second risk tolerance level.

In some embodiments, the first resource trading platform stores the risk assessment data of each user. The risk assessment data stored in the first resource trading platform can be obtained by the user through the risk assessment on the first resource trading platform, or can be obtained by the first resource trading platform from another resource trading platform connected to the blockchain.

The another resource trading platform and the first resource trading platform share the risk assessment data of each user through the blockchain. If the first user updates the risk assessment data through the first resource trading platform or the another resource trading platform, the risk assessment data of the first user stored in each resource trading platform is updated accordingly based on the data sharing between the resource trading platforms, so as to ensure that the risk assessment data in each resource trading platform connected to the blockchain is updated simultaneously.

In some embodiments, the risk assessment data of the first user includes only the risk profile data of the first user, that is, excludes the first risk assessment record of the first user. Then, when it is determined whether to execute the first resource transaction for the first user, risk assessment can be performed based on the risk profile data of the first user, so as to obtain the second risk tolerance level corresponding to the first user. Then, it is determined, based on the second risk tolerance level, whether to execute the first resource transaction for the first user.

In some embodiments, after S202 is performed, that is, after the resource transaction request that is sent by the first user and that includes the digital identity information of the first user is received, the second risk assessment record corresponding to the first user can be first queried from the first resource trading platform to obtain a query result corresponding to the second risk assessment record. In other words, when receiving the resource trading request sent by the first user, the first resource trading platform first queries whether the risk assessment record corresponding to the first user is stored locally. Before receiving the resource transaction request sent by the first user this time, if risk assessment has been performed on the first user through the first resource trading platform, for example, risk assessment is performed when the first user executed a specific resource transaction through the first resource trading platform, the first resource trading platform can locally record the risk assessment result, that is, locally store the second risk assessment record corresponding to the first user.

Therefore, if the previous query result is that the first resource trading platform stores the risk assessment record corresponding to the first user, that is, the second risk assessment record, the identified second risk assessment record is used to determine the risk tolerance level corresponding to the first user, and further determine whether to execute the first resource transaction for the first user. If the query result is a specified type of query result, the relevant authorization information of the risk assessment card corresponding to the first user is queried from the authorization management platform that is connected to the blockchain. The specified type of query result includes at least one of the following: the second risk assessment record is not identified in the first resource trading platform; and a third risk tolerance level corresponding to the first user recorded in the second risk assessment record does not satisfy the transaction level requirement corresponding to the first resource transaction.

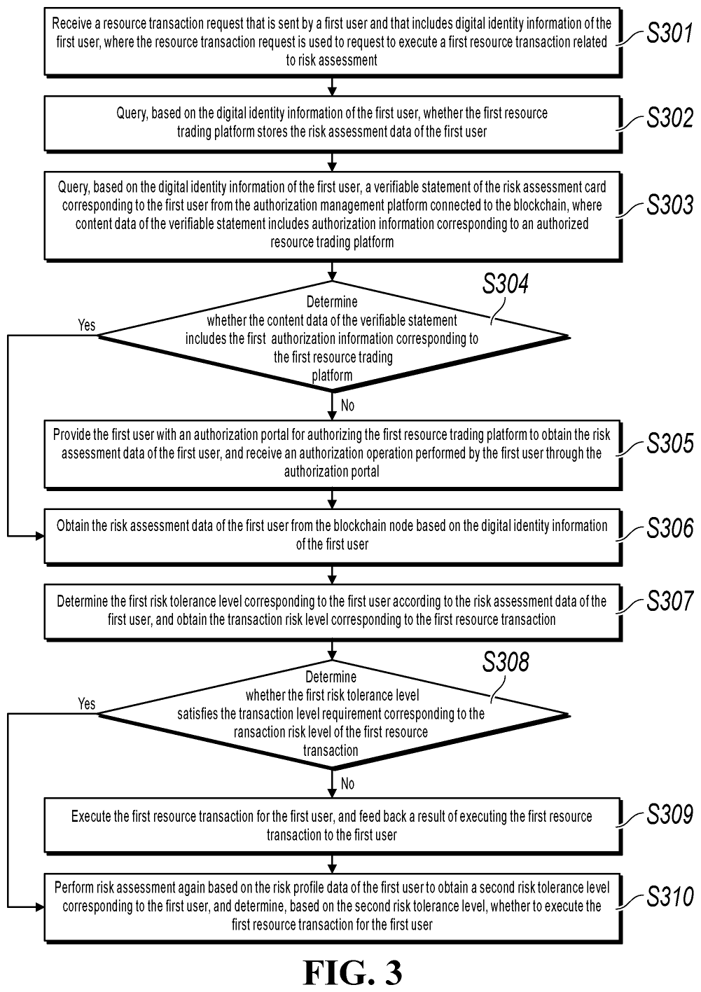

FIG. 3 is a schematic flowchart illustrating an example of a blockchain-based resource transaction method, according to other embodiments of the present specification. As shown in FIG. 3, the method is applied to a first resource trading platform connected to a blockchain. The first resource trading platform can be any one of a plurality of resource trading platforms connected to the blockchain. The method includes the following steps.

S301: Receive a resource transaction request that is sent by a first user and that includes digital identity information of the first user, where the resource transaction request is used to request to execute a first resource transaction related to risk assessment.

S302: Query, based on the digital identity information of the first user, whether the first resource trading platform stores the risk assessment data of the first user. If yes, S307 is performed, or if no, S303 is performed.

The first resource trading platform stores a mapping relationship between the digital identity information and the risk assessment data of each user. The risk assessment data can include risk profile data, a risk assessment record, etc. of the user. The risk profile data can include user identity information (such as the user's age, gender, income range, family situation, and risk assessment questionnaire record), user behavior information (such as payment data, transfer data, transaction data, etc.) generated through the resource trading platform, etc. The risk assessment record includes, for example, a risk assessment result, etc.

S303: Query, based on the digital identity information of the first user, a verifiable statement of the risk assessment card corresponding to the first user from the authorization management platform connected to the blockchain, where content data of the verifiable statement includes authorization information corresponding to an authorized resource trading platform.

S304: Determine whether the content data of the verifiable statement includes the first authorization information corresponding to the first resource trading platform. If yes, S306 is performed, or if no, S305 is performed.

S305: Provide the first user with an authorization portal for authorizing the first resource trading platform to obtain the risk assessment data of the first user, and receive an authorization operation performed by the first user through the authorization portal.

S306: Obtain the risk assessment data of the first user from the blockchain node based on the digital identity information of the first user.

S307: Determine the first risk tolerance level corresponding to the first user based on the risk assessment data of the first user, and obtain the transaction risk level corresponding to the first resource transaction.

The first risk tolerance level corresponding to the first user and the transaction risk level corresponding to the first resource transaction can be displayed on the client interface.

If the risk assessment data includes the risk assessment record of the first user, the first risk tolerance level corresponding to the first user can be determined based on the risk assessment record. If the risk assessment data includes only the risk profile data of the first user, risk assessment can be performed based on the risk profile data through the first resource trading platform, to obtain the first risk tolerance level corresponding to the first user.

Optionally, if the risk assessment data does not include the risk assessment record of the first user, and the risk assessment is performed through the first resource trading platform, the first risk tolerance level obtained after the risk assessment can be uploaded to the blockchain node. The blockchain node records the first risk tolerance level to generate the risk assessment record of the first user.

S308: Determine whether the first risk tolerance level satisfies the transaction level requirement corresponding to the transaction risk level of the first resource transaction. If yes, S309 is performed, or if no, S310 is performed.

After the present step is performed, the result of determining whether the first risk tolerance level satisfies the transaction level requirement corresponding to the transaction risk level can be displayed on the client interface.

Corresponding transaction risk levels can be predetermined for various resource transactions, and the transaction risk levels can be used to represent transaction level requirements corresponding to the resource transactions. In other words, resource transactions with different transaction risk levels correspond to different transaction level requirements, and the transaction level requirements are minimum requirements for the risk tolerance level corresponding to the user. The result of determining whether the first risk tolerance level satisfies the transaction level requirement corresponding to the transaction risk level can satisfy the transaction level requirement or does not satisfy the transaction level requirement.

Risk tolerance levels can include robust, conservative, etc. The transaction risk level corresponding to the resource transaction can be low risk, medium-to-low risk, medium risk, medium-to-high risk, high risk, etc. For example, the transaction level requirement corresponding to a low-risk resource transaction is “robust,” that is, when executing a low-risk resource transaction, the user is required to have at least a “robust” risk tolerance level.

The blockchain node stores the transaction risk level corresponding to each resource transaction. The first resource trading platform can obtain the transaction risk level of the first resource transaction from the blockchain node. Specifically, when the resource trading platform generates a new type of resource transaction, the transaction risk level corresponding to the resource transaction can be uploaded to the blockchain node for storage.

S309: Execute the first resource transaction for the first user, and feed back a result of executing the first resource transaction to the first user.

S310: Perform risk assessment again based on the risk profile data of the first user to obtain a second risk tolerance level corresponding to the first user, and determine, based on the second risk tolerance level, whether to execute the first resource transaction for the first user.

The risk profile data can be included in the risk assessment data obtained in S306.

Optionally, when the assessment request sent by the first user for re-assessing the risk tolerance level is received, the risk profile data of the first user can be displayed on the client interface, and then risk assessment is performed again based on the updating operation performed by the first user on the risk profile data.

The second risk tolerance level obtained after risk assessment is performed again can be uploaded to the blockchain node by the first resource trading platform, so that the blockchain node updates the risk assessment data of the first user based on the second risk tolerance level.

Optionally, the first resource trading platform can alternatively upload the second risk tolerance level to another resource trading platform connected to the blockchain, so that the another resource trading platform updates, based on the second risk tolerance level, the risk assessment data of the first user stored on the another resource trading platform.

It can be determined that, according to the technical solutions in these embodiments, the first resource trading platform obtains the risk assessment data corresponding to the first user from the blockchain node through the risk assessment card, so that when the first user executes the resource transaction through the first resource trading platform, there is no need to repeat the risk assessment, and the user only needs to obtain the risk assessment data of the user from the blockchain node to complete the risk assessment operation in the first resource transaction, thereby simplifying the resource transaction process and improving the processing efficiency of resource transaction. In addition, the user does not need to repeatedly input data when risk assessment is performed on the first resource trading platform, but only needs to obtain the risk profile data of the user from another resource trading platform that implements data sharing, so that the risk assessment data can be shared between resource trading platforms through the blockchain. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

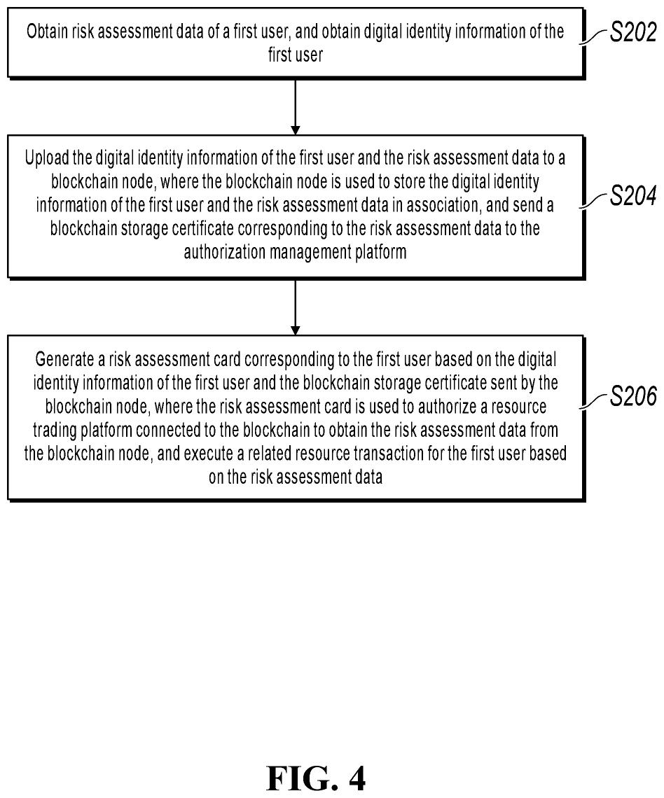

FIG. 4 is a schematic flowchart illustrating an example of a blockchain-based resource transaction method, according to still other embodiments of the present specification. As shown in FIG. 4, the method is applied to an authorization management platform connected to the blockchain and includes the following steps:

S402: Obtain risk assessment data of a first user, and obtain digital identity information of the first user.

The risk assessment data can include risk profile data, a risk assessment record, etc. of the user. The risk profile data can include user identity information (such as the user's age, gender, income range, family situation, risk assessment questionnaire record, etc.), user behavior information (such as payment data, transfer data, transaction data, etc.) generated through the resource trading platform, etc. The risk assessment record includes, for example, a risk assessment result, etc.

The digital identity information of the first user can be a decentralized identity (DID), that is, a distributed digital identifier, which can be created in advance based on the blockchain, and features tamper-resistance upon creation once.

S404: Upload the digital identity information of the first user and the risk assessment data to a blockchain node, where the blockchain node is used to store the digital identity information of the first user and the risk assessment data in association, and send a blockchain storage certificate corresponding to the risk assessment data to the authorization management platform.

The blockchain storage certificate can be a hash value generated by the blockchain node.

S406: Generate a risk assessment card corresponding to the first user based on the digital identity information of the first user and the blockchain storage certificate sent by the blockchain node, where the risk assessment card is used for a resource trading platform connected to the blockchain to obtain the risk assessment data from the blockchain node, and execute a related resource transaction for the first user based on the risk assessment data.

The blockchain node is used to store risk assessment data corresponding to each user. The digital identity information of each user is stored in association with the corresponding risk assessment data in the blockchain node.

According to the technical solutions in one or more embodiments of the present specification, the risk assessment data of the first user and the digital identity information of the first user are obtained and uploaded to the blockchain node, so that the blockchain node stores the digital identity information and the risk assessment data of the first user in association, and sends the blockchain storage certificate corresponding to the risk assessment data to the authorization management platform; and then the authorization management platform generates a risk assessment card corresponding to the first user based on the blockchain storage certificate. In this way, the first user can authorize, through the risk assessment card, a resource trading platform connected to the blockchain to obtain the risk assessment data from the blockchain node, so that when the first user executes the resource transaction through the first resource trading platform, there is no need to repeat the risk assessment, and the user only needs to obtain the risk assessment data of the user from the blockchain node to complete the risk assessment operation in the first resource transaction, thereby simplifying the resource transaction process and improving the processing efficiency of resource transaction. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

In the previous embodiments, when S402 is performed, the digital identity information of the first user can be obtained in any one of the following methods:

Method 1: Search for the digital identity information of the first user from digital identity information of each user generated in advance.

Optionally, when the first user executes a service on the authorization management platform for a non-first time, because the digital identity information corresponding to the first user has already been created when the first user executes a service through the authorization management platform for the first time, the first user can directly search for the digital identity information corresponding to the first user from various digital identity information stored in the authorization management platform when the first user executes a service on the authorization management platform for the second time, the third time, etc. Specifically, the authorization management platform can store a mapping relationship between the user identification information and the digital identity information of each user.

In addition, in other specific implementations, regardless of whether the user executes a service on the authorization management platform, the authorization management platform can pre-create the digital identity information corresponding to each user. In this way, when a target user needs to execute a service through the authorization management platform, the target user directly searches for the digital identity information corresponding to the target user from the digital identity information corresponding to each user stored in the authorization management platform.

Optionally, during specific implementation, the authorization management platform can create the digital identity information of the first user based on the user identification information corresponding to the first user on the resource trading platform, or create the digital identity information corresponding to the first user based on the account information registered by the first user on the resource trading platform. Specifically, the authorization management platform can obtain the previous information of the first user from the resource trading platform, and create and store the digital identity information of each user based on the obtained information.

Method 2: Create the digital identity information of the first user based on user identification information stored by the first user in each resource trading platform.

The user identification information stored by the first user in each resource trading platform includes personal information (such as the user's age, gender, identity card number, etc.) corresponding to the first user in the resource trading platform, and/or login account information of the first user in the resource trading platform during risk assessment.

Specifically, when the first user executes a service through the authorization management platform for the first time, the digital identity information corresponding to the first user needs to be created. The digital identity information can be created based on the user identification information stored by the first user on the resource trading platform, or be created based on the login account information of the first user in the resource trading platform during risk assessment. The specific information based on which the digital identity information is created can be set based on actual application needs, which is not limited in the embodiments of the present specification.

In addition, it is worthwhile to note that one user may register a plurality of accounts on the resource trading platform. Therefore, when digital identity information is created based on the account information of the first user on the resource trading platform, the digital identity information can be created based on the login identity information of the first user in the resource trading platform during risk assessment. For example, if the first user logs in to account A on the resource trading platform to perform risk assessment, the authorization management platform creates the digital identity information of the first user based on account A after receiving the risk assessment information of the first user sent by the resource trading platform.

In the previous embodiments, when S402 is performed, the risk assessment data of the first user can be obtained in any one or more of the following methods:

Method 1: Obtain the risk profile data of the first user included in the risk assessment data from the resource trading platform connected to the blockchain. Specifically, the resource trading platform connected to the blockchain stores the risk profile data corresponding to each user.

Specifically, the resource trading platform connected to the blockchain stores the digital identity information of each user and the corresponding risk profile data in association. The authorization management platform can obtain the risk profile data of the first user from at least one resource trading platform based on the digital identity information corresponding to the first user. The resource trading platform is one or more of the resource trading platforms connected to the blockchain. The resource trading platforms share the risk profile data through the blockchain.

Method 2: Obtain the risk assessment record of the first user included in the risk assessment data from the resource trading platform connected to the blockchain; and/or perform risk assessment based on the risk profile data obtained from the resource trading platform, so as to obtain the risk assessment record of the first user. The risk assessment record is used to record the risk tolerance level obtained after risk assessment is performed on the first user, such as robust, conservative, etc.

Before the risk assessment record and/or the risk profile data of the first user are/is obtained from the resource trading platform, the first user can give corresponding authorization. Specifically, the authorization management platform receives the first authorization operation performed by the first user, and the first authorization operation is used to authorize the authorization management platform to obtain the risk profile data and/or the risk assessment record of the first user from the resource trading platform connected to the blockchain. After the first authorization operation is received, the risk profile data and/or the risk assessment record of the first user can be obtained from the resource trading platform connected to the blockchain. Before the risk assessment is performed based on the risk profile data obtained from the resource trading platform, the first user can also give authorization. Specifically, the authorization management platform receives a second authorization operation performed by the first user, and the second authorization operation is used to authorize the authorization management platform to perform risk assessment based on the risk profile data. After the second authorization operation is received, the risk assessment can be performed based on the risk profile data.

In addition to recording the risk tolerance level corresponding to the first user, the first risk assessment record can further record one or more types of the following information: user identification information of the first user on the resource trading platform, login account information of the first user for the risk assessment, risk assessment number information of the first user for the risk assessment, time information of the first user for the risk assessment, identification information of a risk assessment platform that performs risk assessment on the first user, etc. Certainly, in addition to the content listed above, the content included in the risk assessment record can further include other content. The previous description lists only examples of some types of possible information, and does not constitute a limitation on the embodiments of the present specification.

Specifically, when the first user needs to perform risk assessment, it is generally necessary to fill in the risk assessment questionnaire on the client device corresponding to the resource trading platform, and send the risk assessment questionnaire information filled in by the first user to a risk assessment platform. The risk assessment platform performs calculation through a risk assessment model based on the risk assessment questionnaire information, and the collected income information, asset information, family information, historical purchase and financing information, etc. of the first user, to obtain the risk assessment result corresponding to the first user. Then, the generated risk assessment result and other related information (such as user identification information, account information, risk assessment number information, resource transaction serial number, risk assessment time information, etc.) are sent to the authorization management platform as a risk assessment record.

In some embodiments, before the digital identity information of the first user and the risk assessment data are uploaded to the blockchain node, a verifiable statement corresponding to the risk assessment data of the first user can be first obtained, where content data of the verifiable statement includes the digital identity information and the risk assessment data of the first user. Based on the previous description, when the digital identity information and the risk assessment data of the first user are uploaded to the blockchain node, the content data of the verifiable statement can be uploaded to the blockchain node. The blockchain node is used to store the content data of the verifiable statement, and send the blockchain storage certificate corresponding to the verifiable statement to the authorization management platform.

The verifiable statement corresponding to the risk assessment data can be obtained in any one of the following methods.

(1) The authorization management platform creates the verifiable statement corresponding to the risk assessment data.

The authorization management platform generates the corresponding verifiable statement based on the digital identity information and the risk assessment data of the first user, determines the digital identity information and the risk assessment data of the first user as the content data of the verifiable statement, and uploads the content data of the verifiable statement to the blockchain node for storage. The created verifiable statement is used to declare the risk assessment data corresponding to the digital identity information.

(2) The blockchain node creates the verifiable statement corresponding to the risk assessment data, and the authorization management platform obtains the verifiable statement corresponding to the risk assessment data from the blockchain node.

In this method, the authorization management platform sends the digital identity information and the risk assessment data of the first user to the blockchain node. The blockchain node generates the corresponding verifiable statement based on the digital identity information and the risk assessment data of the first user, and determines the digital identity information and the risk assessment data of the first user as the content data of the verifiable statement.

Optionally, the authorization management platform can send a request for creating a verifiable statement to the blockchain node, where the creation request includes the digital identity information and the risk assessment data of the first user. After receiving the creation request sent by the authorization management platform, the blockchain node creates the previous verifiable statement based on the digital identity information and the risk assessment data in the creation request. The created verifiable statement is used to declare the risk assessment data corresponding to the digital identity information. After completing the creation of the verifiable statement, the blockchain node returns the verifiable statement to the authorization management platform.

In some embodiments, after generating the verifiable statement corresponding to the risk assessment data of the first user, and before uploading the content data of the verifiable statement to the blockchain node, the authorization management platform receives a third authorization operation performed by the first user through the authorization management platform, where the third authorization operation is used to authorize a second resource trading platform connected to the blockchain to obtain risk assessment data through a risk assessment card; and generates authorization information corresponding to the second resource trading platform based on the third authorization operation. Further, when the content data of the verifiable statement is uploaded to the blockchain node, the authorization information corresponding to the second resource trading platform is first stored in the content data of the verifiable statement, and then the content data of the verifiable statement is uploaded to the blockchain node. Based on the previous description, the verifiable statement serves two purposes: authorization verification; and storage of risk assessment data.

Optionally, the authorization information corresponding to the second resource trading platform can be stored in association with the digital identity information of the first user on the authorization management platform. After the risk assessment card is generated, the authorization information corresponding to the second resource trading platform can be stored in association with the digital identity information of the first user and the verifiable statement corresponding to the risk assessment card on the authorization management platform.

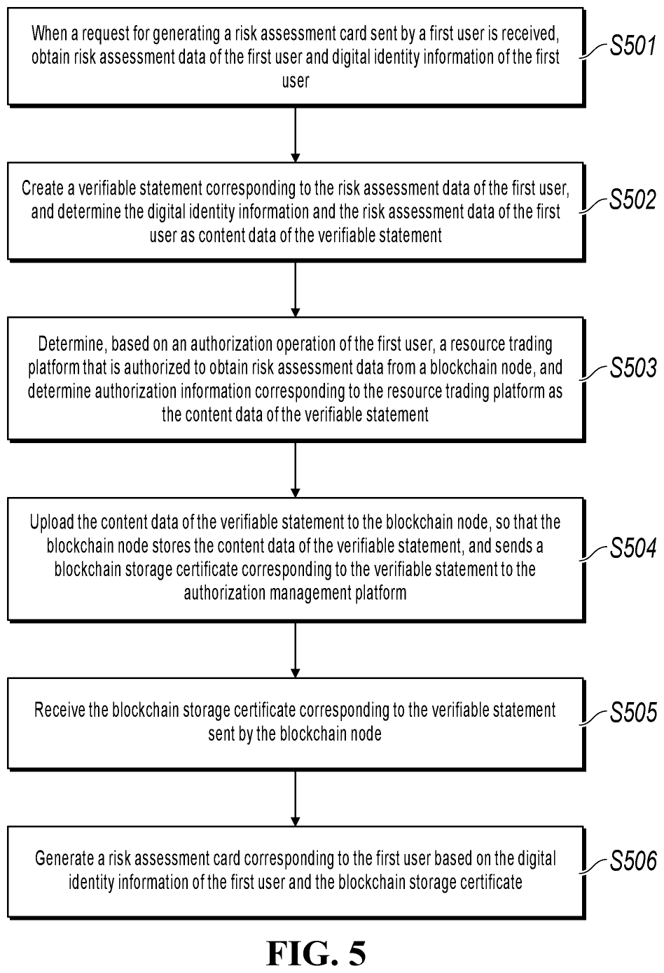

FIG. 5 is a schematic flowchart illustrating an example of a blockchain-based resource transaction method, according to still other embodiments of the present specification. As shown in FIG. 5, the method is applied to an authorization management platform connected to the blockchain and includes the following steps.

S501: When a request for generating a risk assessment card sent by a first user is received, obtain risk assessment data of the first user and digital identity information of the first user.

The method for obtaining risk assessment data and digital identity information has been described in detail in the previous embodiments, and details are omitted here for simplicity.

S502: Create a verifiable statement corresponding to the risk assessment data of the first user, and determine the digital identity information and the risk assessment data of the first user as content data of the verifiable statement.

S503: Determine, based on an authorization operation of the first user, a resource trading platform that is authorized to obtain risk assessment data from a blockchain node, and determine authorization information corresponding to the resource trading platform as the content data of the verifiable statement.

The authorization operation of the first user can be completed through the authorization management platform. Specifically, the first user performs the authorization operation on the authorization management client device corresponding to the authorization management platform, and submits the authorization operation to the authorization management platform, and then the authorization management platform confirms the authorization operation of the first user. After the authorization operation of the first user is determined, the authorization management platform generates authorization information corresponding to the authorized resource trading platform.

S504: Upload the content data of the verifiable statement to the blockchain node, so that the blockchain node stores the content data of the verifiable statement, and sends a blockchain storage certificate corresponding to the verifiable statement to the authorization management platform.

The content data of the verifiable statement uploaded to the blockchain node includes the authorization information corresponding to the authorized resource trading platform, the digital identity information of the first user, and the risk assessment data of the first user. The verifiable statement serves two purposes: authorization verification; and storage of risk assessment data.

S505: Receive the blockchain storage certificate corresponding to the verifiable statement sent by the blockchain node.

S506: Generate a risk assessment card corresponding to the first user based on the digital identity information of the first user and the blockchain storage certificate.

The following uses a specific scenario as an example to describe an implementation process of the blockchain-based resource transaction method provided in the present specification.

For example, the resource transaction is a funds transaction in the financial field, and the resource trading platform connected to the blockchain is XX banking institution. The user generates a risk assessment card through the authorization management platform, and uploads risk assessment data of the user to the blockchain node for storage through the risk assessment card. Later, when the user executes a funds transaction through XX banking institution (that is, purchases funds issued by XX Bank), the user can obtain risk assessment data from the blockchain node under the premise of authorizing XX banking institution through the risk assessment card, and determine, based on the obtained risk assessment data, whether the user can purchase the funds.

The following first describes how to receive and generate a risk assessment card through the authorization management platform.

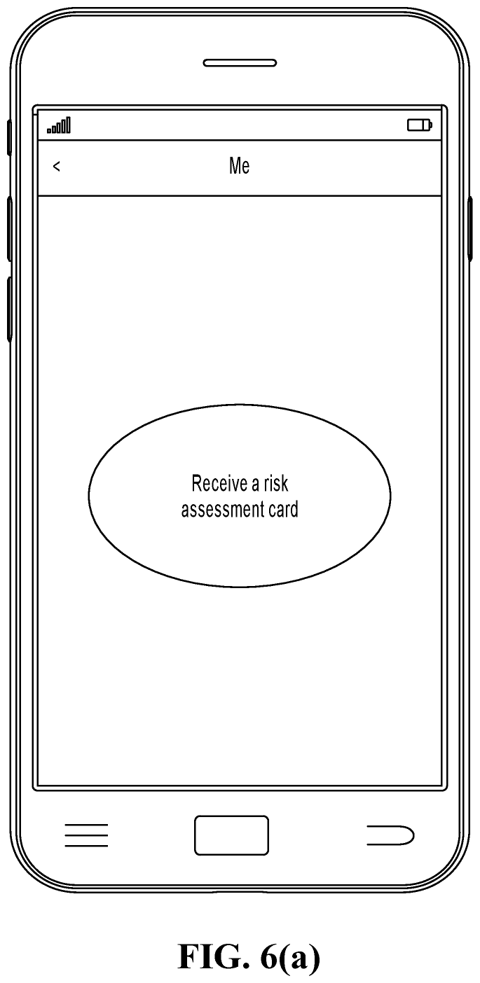

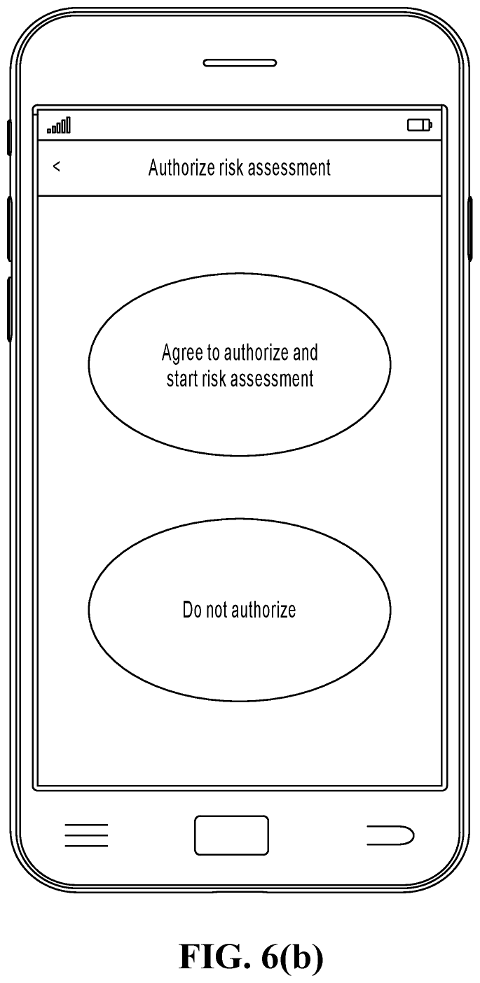

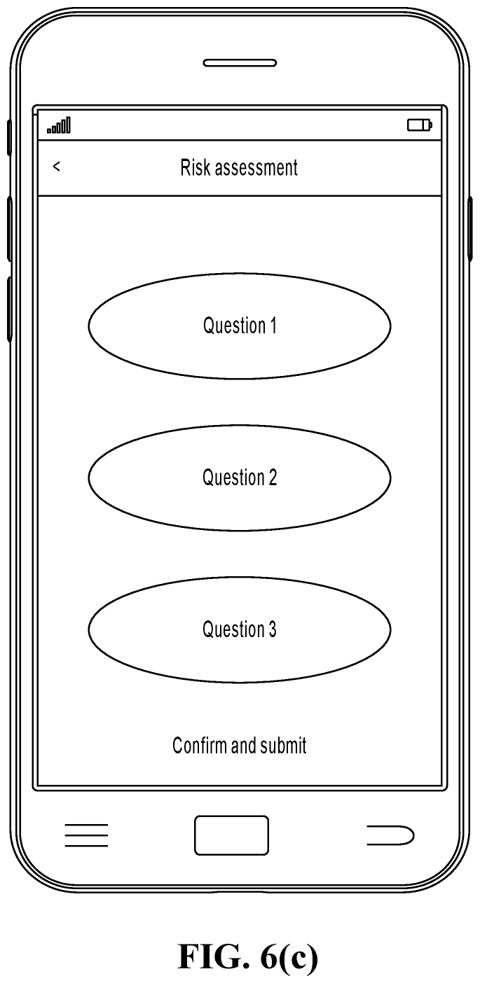

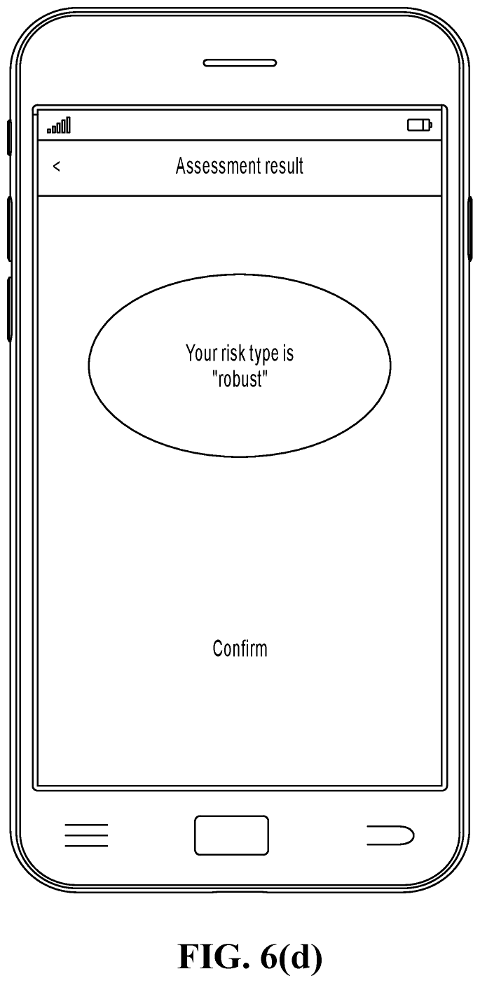

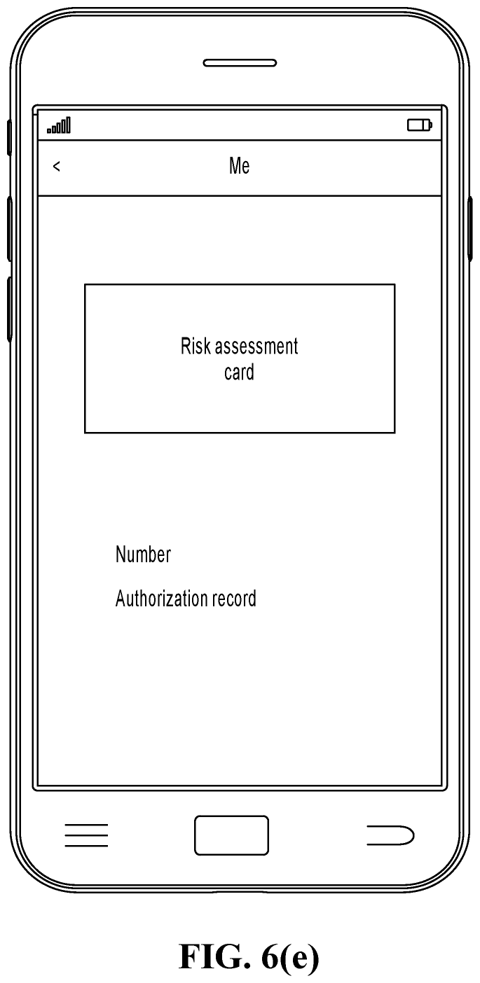

FIG. 6(a) to FIG. 6(e) show a process of generating a risk assessment card. As shown in FIG. 6(a), a user sends a request for generating a risk assessment card through an authorization management client device corresponding to the authorization management platform, such as tapping “Receive a risk assessment card” in FIG. 6(a). After receiving the request for generating a risk assessment card, the authorization management platform obtains risk assessment data of the user. The risk assessment data can include risk profile data, a risk assessment record, etc. of the user. The risk profile data can include user identity information (such as the user's age, gender, income range, family situation, risk assessment questionnaire record, etc.), user behavior information (such as payment data, transfer data, transaction data, etc.) generated through the resource trading platform, etc. The risk assessment record includes at least a risk assessment result of the user, and the risk assessment result is used to represent a risk tolerance level corresponding to the user, such as robust, conservative, etc. The method in which the authorization management platform obtains the risk assessment data of the user has been described in detail in the previous embodiments, and details are omitted here for simplicity.

If the risk assessment data obtained by the authorization management platform includes the risk profile data and the risk assessment record of the user, the risk tolerance level corresponding to the user in the risk assessment record is displayed on a display interface of the authorization management client device, so that the user confirms his/her risk tolerance level, as shown in FIG. 6(d).

If the risk assessment data obtained by the authorization management platform includes only the risk profile data of the user, that is, excludes the risk assessment record of the user, risk assessment can be performed based on the risk profile data of the user. First, an authorization portal for risk assessment is displayed on the display interface of the authorization management client device, as shown in FIG. 6(b). If the user taps “Agree to authorize and start risk assessment” on the interface shown in FIG. 6(b), the display interface of the authorization management client device jumps to the interface shown in FIG. 6(c). That is, risk profile data (such as the questions displayed on the interface) corresponding to the user is displayed for the user to confirm or modify, and to authorize a risk assessment operation after confirmation, such as tapping “Confirm and submit” on the interface shown in FIG. 6(c), as shown in FIG. 6(b).

After performing risk assessment based on the risk profile data of the user, the authorization management platform displays a risk assessment result after the risk assessment on the display interface of the client device, as shown in FIG. 6(d). The interface displays the risk assessment result “Robust,” indicating that the user has a robust risk tolerance level. When the user taps the “Confirm” key on the interface shown in FIG. 6(d), the authorization management platform uploads the digital identity information and the risk assessment data of the user to the blockchain node for storage. After receiving a blockchain storage certificate returned by the blockchain node, the authorization management platform generates a risk assessment card of the user, as shown in FIG. 6(e). The risk assessment card corresponds to a unique number. The number of the risk assessment card can be generated by the authorization management platform and is associated with the blockchain storage certificate generated by the blockchain node. “Authorization record” in the lower part of the risk assessment card is used to display the user's authorization record for each financial institution connected to the blockchain through the risk assessment card. After a financial institution is authorized, the financial institution has the right to obtain the risk assessment data of the user from the blockchain node.

So far, the authorization management platform has generated a risk assessment card for the user, and the user can authorize each financial institution connected to the blockchain through the risk assessment card, and execute a funds transaction through the authorized financial institution. The following describes in detail the use of the user's risk assessment card in a funds transaction scenario.

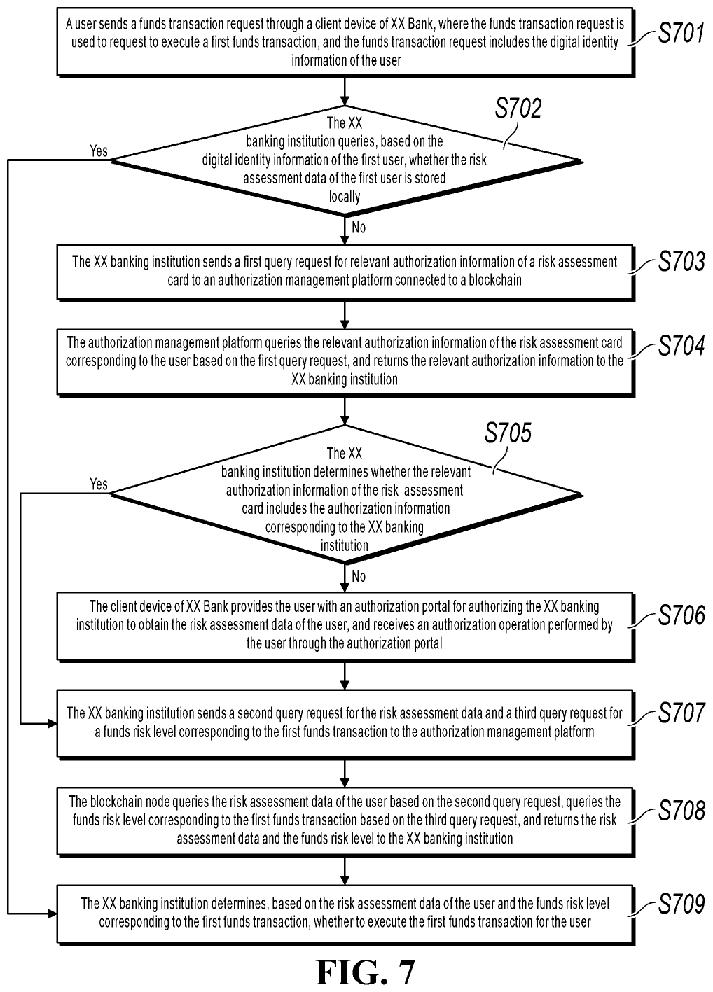

FIG. 7 is a schematic flowchart illustrating an example of a blockchain-based resource transaction method, according to still other embodiments of the present specification. In these embodiments, it is assumed that the user performs a funds purchase operation on a client interface of XX Bank. As shown in FIG. 7, the method includes the following steps:

S701: The user sends a funds transaction request through a client device of XX Bank. The funds transaction request is used to request to execute a first funds transaction, and the funds transaction request includes the digital identity information of the user.

S702: The XX banking institution queries, based on the digital identity information of the first user, whether the risk assessment data of the first user is stored locally. If yes, S709 is performed, or if no, S703 is performed.

S703: The XX banking institution sends a first query request for relevant authorization information of a risk assessment card to an authorization management platform connected to a blockchain.

The relevant authorization information of the risk assessment card can include authorization information corresponding to each authorized banking institution, and each authorized banking institution can be allowed to obtain the risk assessment data of the first user from the blockchain node.

In the present step, the condition for performing S703 is that the XX banking institution does not store the risk assessment data of the first user. In practice, the condition for performing S703 can alternatively be that if the XX banking institution has stored the risk assessment data of the first user, but it is determined, based on the risk assessment data, that the risk tolerance level of the first user is insufficient for executing the first funds transaction. In other words, the risk assessment data stored in the XX banking institution may not be updated in time, or the risk assessment questionnaire record of the first user includes expired information. As a result, the determined risk tolerance level of the first user is not accurate enough. In this case, S703 and subsequent steps can be performed, that is, the risk assessment card can be used to determine the risk tolerance level.

S704: The authorization management platform queries the relevant authorization information of the risk assessment card corresponding to the user based on the first query request, and returns the relevant authorization information to the XX banking institution.

Specifically, the first query request includes the digital identity information of the user, and the authorization management platform can query the relevant authorization information of the risk assessment card corresponding to the user based on the digital identity information in the first query request.

S705: The XX banking institution determines whether the relevant authorization information of the risk assessment card includes the authorization information corresponding to the XX banking institution. If yes, S707 is performed, or if no, S706 is performed.

S706: The client device of XX Bank provides the user with an authorization portal for authorizing the XX banking institution to obtain the risk assessment data of the user, and receives an authorization operation performed by the user through the authorization portal.

S707: The XX banking institution sends a second query request for the risk assessment data and a third query request for a funds risk level corresponding to the first funds transaction to the authorization management platform.

The blockchain node pre-stores funds risk levels corresponding to various funds transactions, such as low risk, medium-to-low risk, medium risk, medium-to-high risk, high risk, etc.

S708: The blockchain node queries the risk assessment data of the user based on the second query request, queries the funds risk level corresponding to the first funds transaction based on the third query request, and returns the risk assessment data and the funds risk level to the XX banking institution.

Specifically, the second query request includes the digital identity information of the user, and the blockchain node can query the risk assessment data of the user based on the digital identity information in the second query request.

S709: The XX banking institution determines, based on the risk assessment data of the user and the funds risk level corresponding to the first funds transaction, whether to execute the first funds transaction for the user.

Specifically, the XX banking institution can determine the risk tolerance level corresponding to the user based on the risk assessment data of the user, and further determines whether the risk tolerance level corresponding to the user satisfies a transaction level requirement corresponding to the funds risk level corresponding to the first funds transaction.

If the risk assessment data includes the risk assessment record of the user, the risk tolerance level corresponding to the user can be determined based on the risk assessment record. If the risk assessment data includes only the risk profile data of the user, the XX banking institution can perform risk assessment based on the risk profile data to obtain the risk tolerance level corresponding to the user.

It can be determined that, according to the technical solutions in these embodiments, when receiving the funds transaction request sent by the user, the financial institution queries the relevant authorization information of the risk assessment card corresponding to the user from the authorization management platform that is connected to the blockchain. The risk assessment card is used for the financial institution to obtain the risk assessment data corresponding to the user. In addition, the financial institution determines, based on the relevant authorization information, whether the financial institution is authorized to obtain the risk assessment data of the user, and if yes, obtains the risk assessment data of the user from the blockchain node, and further determines, based on the risk assessment data, whether to execute the funds transaction for the user. It can be determined that the financial institution obtains the risk assessment data corresponding to the user from the blockchain node through the risk assessment card, so that when the user executes the funds transaction through the financial institution, there is no need to repeat the risk assessment, and the user only needs to obtain the risk assessment data of the user from the blockchain node to complete the risk assessment operation in the funds transaction, thereby simplifying the funds transaction process and improving the funds transaction efficiency. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

In summary, the specific embodiments of this subject matter have been described. Other embodiments fall within the scope of the appended claims. In some situations, the actions described in the claims can be performed in a different order and the desired results can still be achieved. In addition, the process depicted in the accompanying drawings does not necessarily require a particular execution order to achieve the desired results. In some implementations, multi-tasking and concurrent processing may be advantageous.

The foregoing has described the blockchain-based resource transaction method provided in one or more embodiments of the present specification. Based on the same idea, one or more embodiments of the present specification further provide blockchain-based resource transaction apparatuses.

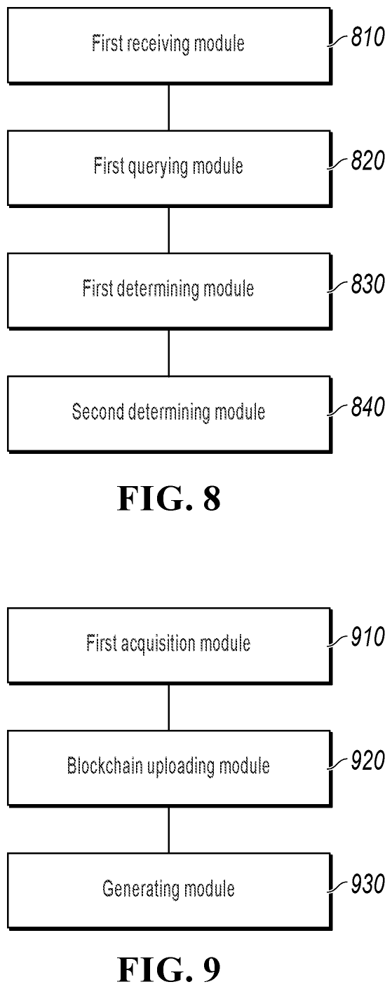

FIG. 8 is a schematic block diagram illustrating an example of a blockchain-based resource transaction apparatus, according to some embodiments of the present specification. As shown in FIG. 8, the blockchain-based resource transaction apparatus is applied to a first resource trading platform connected to a blockchain, and the apparatus includes the following: a first receiving module 810, configured to receive a resource transaction request that is sent by a first user and that includes digital identity information of the first user, where the resource transaction request is used to request to execute a first resource transaction related to risk assessment; a first querying module 820, configured to query, based on the digital identity information, relevant authorization information of a risk assessment card corresponding to the first user from an authorization management platform that is connected to the blockchain, where the risk assessment card is used for a resource trading platform to obtain risk assessment data corresponding to the first user; a first determining module 830, configured to determine, based on the relevant authorization information, whether the first resource trading platform is authorized to obtain the risk assessment data of the first user, and if yes, obtain the risk assessment data of the first user from a blockchain node, where the blockchain node is used to store risk assessment data corresponding to each user; and a second determining module 840, configured to determine, based on the risk assessment data of the first user, whether to execute the first resource transaction for the first user.

In some embodiments, the first querying module 820 includes the following: a first querying unit, configured to query a verifiable statement of the risk assessment card corresponding to the first user from the authorization management platform, where content data of the verifiable statement includes authorization information corresponding to an authorized resource trading platform; and the first determining module 830 includes the following: a first determining unit, configured to determine whether the content data of the verifiable statement includes first authorization information corresponding to the first resource trading platform, and if yes, determine whether the first resource trading platform is authorized to obtain the risk assessment data of the first user.

In some embodiments, the apparatus further includes the following: a providing module, configured to: after the determining whether the verifiable statement includes first authorization information corresponding to the first resource trading platform, if the content data of the verifiable statement does not include the first authorization information corresponding to the first resource trading platform, provide the first user with an authorization portal for authorizing the first resource trading platform to obtain the risk assessment data of the first user; and a third determining module, configured to: when an authorization operation performed by the first user through the authorization portal is received, determine, based on the authorization operation, that the first resource trading platform is authorized to obtain the risk assessment data of the first user.

In some embodiments, the apparatus further includes the following: a sending module, configured to: after the authorization operation performed by the first user through the authorization portal is received, send the first authorization information to the authorization management platform, so that the authorization management platform updates the relevant authorization information of the risk assessment card corresponding to the first user based on the first authorization information.

In some embodiments, the risk assessment data includes a first risk assessment record of the first user, and the first risk assessment record is used to record a first risk tolerance level obtained after risk assessment is performed on the first user; and the second determining module 840 includes the following: a determining unit, configured to determine, based on the first risk assessment record, whether the first risk tolerance level corresponding to the first user satisfies a transaction level requirement corresponding to the first resource transaction, to obtain a determining result; and feed back the determining result to the first user; and an executing unit, configured to: if the first risk tolerance level corresponding to the first user satisfies the transaction level requirement corresponding to the first resource transaction, execute the first resource transaction for the first user, and feed back a resource transaction result corresponding to the first resource transaction to the first user.

In some embodiments, the risk assessment data further includes risk profile data of the first user; and the second determining module 840 further includes the following: a displaying unit, configured to: if the first risk tolerance level corresponding to the first user does not satisfy the transaction level requirement corresponding to the first resource transaction, display the risk profile data to the first user when an assessment request of the first user for re-assessing a risk tolerance level is received; a first updating unit, configured to: when an updating operation of the first user for the risk profile data is received, update the risk profile data based on the updating operation; a first assessing unit, configured to re-assess the risk tolerance level of the first user based on the updated risk profile data, to obtain a second risk tolerance level corresponding to the first user; and a second determining unit, configured to determine, based on the second risk tolerance level, whether to execute the first resource transaction for the first user.

In some embodiments, the second determining module 840 further includes the following: a second updating unit, configured to: after the re-assessing the risk tolerance level of the first user based on the updated risk profile data, to obtain a second risk tolerance level corresponding to the first user, update, based on the second risk tolerance level, the first risk assessment record corresponding to the first user stored in the blockchain node.

In some embodiments, the apparatus further includes the following: a second querying module, configured to: after the receiving a resource transaction request that is sent by a first user and that includes digital identity information of the first user, query a second risk assessment record corresponding to the first user from the first resource trading platform to obtain a query result corresponding to the second risk assessment record; and the first querying module 820 includes the following: a second querying unit, configured to: if the query result is a specified type of query result, query the relevant authorization information of the risk assessment card corresponding to the first user from the authorization management platform that is connected to the blockchain, where the specified type of query result includes at least one of the following: the second risk assessment record is not identified in the first resource trading platform; and a third risk tolerance level corresponding to the first user recorded in the second risk assessment record does not satisfy the transaction level requirement corresponding to the first resource transaction.

According to the apparatus in one or more embodiments of the present specification, when receiving the resource transaction request sent by the first user, the first resource trading platform queries the relevant authorization information of the risk assessment card corresponding to the first user from the authorization management platform that is connected to the blockchain. The risk assessment card is used for the resource trading platform to obtain the risk assessment data corresponding to the first user. In addition, the first resource trading platform determines, based on the relevant authorization information, whether the first resource trading platform is authorized to obtain the risk assessment data of the first user, and if yes, obtains the risk assessment data of the first user from the blockchain node, and further determines, based on the risk assessment data, whether to execute the resource transaction for the first user. It can be determined that the first resource trading platform obtains the risk assessment data corresponding to the first user from the blockchain node through the risk assessment card, so that when the first user executes the resource transaction through the first resource trading platform, there is no need to repeat the risk assessment, and the user only needs to obtain the risk assessment data of the user from the blockchain node to complete the risk assessment operation in the first resource transaction, thereby simplifying the resource transaction process and improving the processing efficiency of resource transaction. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

A person skilled in the art should understand that the previous blockchain-based resource transaction apparatuses can be used to implement the previous blockchain-based resource transaction methods that are applied to the first resource trading platform. The detailed description of the apparatuses should be similar to the description of the methods, and details are omitted herein for simplicity.

FIG. 9 is a schematic block diagram illustrating an example of a blockchain-based resource apparatus, according to other embodiments of the present specification. As shown in FIG. 9, the blockchain-based resource transaction apparatus is applied to an authorization management platform connected to a blockchain, and the apparatus includes the following: a first acquisition module 910, configured to obtain risk assessment data of a first user, and obtain digital identity information of the first user; a blockchain uploading module 920, configured to upload the digital identity information of the first user and the risk assessment data to a blockchain node, where the blockchain node is used to store the digital identity information of the first user and the risk assessment data in association, and send a blockchain storage certificate corresponding to the risk assessment data to the authorization management platform; and a generating module 930, configured to generate a risk assessment card corresponding to the first user based on the digital identity information of the first user and the blockchain storage certificate sent by the blockchain node, where the risk assessment card is used for a resource trading platform connected to the blockchain to obtain the risk assessment data from the blockchain node, and execute a related resource transaction for the first user based on the risk assessment data.

In some embodiments, the apparatus further includes the following: a second acquisition module, configured to: before the uploading the digital identity information of the first user and the risk assessment data to a blockchain node, obtain a verifiable statement corresponding to the risk assessment data, where content data of the verifiable statement includes the digital identity information of the first user and the risk assessment data; and the blockchain uploading module 920 includes the following: a first uploading unit, configured to upload the content data of the verifiable statement to a blockchain node, where the blockchain node is used to store the content data of the verifiable statement, and send the blockchain storage certificate corresponding to the verifiable statement to the authorization management platform.

In some embodiments, the second acquisition module includes the following: a first creating unit, configured to create the verifiable statement corresponding to the risk assessment data; or a third acquisition unit, configured to obtain the verifiable statement corresponding to the risk assessment data created by the blockchain node.

In some embodiments, the risk assessment data includes risk profile data of the first user; and the first acquisition module 910 includes the following: a first acquisition unit, configured to obtain risk profile data of the first user from a first resource trading platform based on the digital identity information corresponding to the first user, where the first resource trading platform is one or more resource trading platforms connected to the blockchain, and the risk profile data is shared among the resource trading platforms through the blockchain.

In some embodiments, the risk assessment data further includes a risk assessment record of the first user, and the risk assessment record is used to record a risk tolerance level obtained after risk assessment is performed on the first user; and the first acquisition module includes the following: a second acquisition unit, configured to obtain the risk assessment record of the first user from the first resource trading platform; and/or a second assessing unit, configured to perform risk assessment based on the risk profile data obtained from the first resource trading platform, to obtain the risk assessment record of the first user.

In some embodiments, the first acquisition module 910 further includes the following: a first receiving unit, configured to receive a first authorization operation performed by the first user through the authorization management platform, where the first authorization operation is used to authorize the authorization management platform to obtain the risk profile data and/or the risk assessment record of the first user from the first resource trading platform.

In some embodiments, the apparatus further includes the following: a receiving module, configured to: before the performing risk assessment based on the risk profile data obtained from the first resource trading platform, receive a second authorization operation performed by the first user through the authorization management platform, where the second authorization operation is used to authorize the authorization management platform to perform risk assessment based on the risk profile data.

In some embodiments, the blockchain uploading module 920 further includes the following: a second receiving unit, configured to: before the uploading the content data of the verifiable statement to a blockchain node, receive a third authorization operation performed by the first user through the authorization management platform, where the third authorization operation is used to authorize a second resource trading platform connected to the blockchain to obtain the risk assessment data based on the risk assessment card; a generating unit, configured to generate authorization information corresponding to the second resource trading platform based on the third authorization operation; and a first uploading unit, configured to store the authorization information corresponding to the second resource trading platform in the content data of the verifiable statement; and upload the content data of the verifiable statement to the blockchain node.

In some embodiments, the first acquisition module 910 includes the following: a searching unit, configured to search for the digital identity information of the first user from digital identity information of each user generated in advance; or a second creating unit, configured to create the digital identity information of the first user based on user identification information stored by the first user in each resource trading platform.

According to the apparatus in one or more embodiments of the present specification, the risk assessment data of the first user and the digital identity information of the first user are obtained and uploaded to the blockchain node, so that the blockchain node stores the digital identity information and the risk assessment data of the first user in association, and sends the blockchain storage certificate corresponding to the risk assessment data to the authorization management platform; and then the authorization management platform generates a risk assessment card corresponding to the first user based on the blockchain storage certificate. In this way, the first user can authorize, through the risk assessment card, a resource trading platform connected to the blockchain to obtain the risk assessment data from the blockchain node, so that when the first user executes the resource transaction through the first resource trading platform, there is no need to repeat the risk assessment, and the user only needs to obtain the risk assessment data of the user from the blockchain node to complete the risk assessment operation in the first resource transaction, thereby simplifying the resource transaction process and improving the processing efficiency of resource transaction. In addition, the risk assessment data of the user is uniformly stored in the blockchain node, thereby improving an effect of centralized management of the user's risk assessment data, and ensuring that the risk assessment data is not tampered with, that is, ensuring the security and authenticity of the risk assessment data.

A person skilled in the art should understand that the previous blockchain-based resource transaction apparatuses can be used to implement the previous blockchain-based resource transaction methods that are applied to the authorization management platform. The detailed description of the apparatuses should be similar to the description of the methods, and details are omitted herein for simplicity.

Based on the same idea, one or more embodiments of the present specification further provide a blockchain-based resource transaction system.

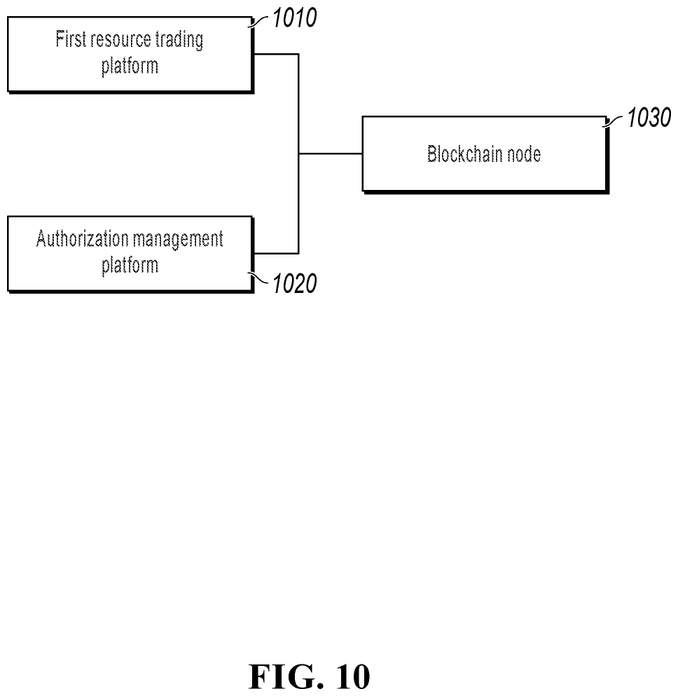

FIG. 10 is a schematic block diagram illustrating an example of a blockchain-based resource system, according to some embodiments of the present specification. As shown in FIG. 10, the blockchain-based resource transaction system includes the following: a first resource trading platform 1010 connected to a blockchain, configured to receive a resource transaction request that is sent by a first user and that includes digital identity information of the first user, where the resource transaction request is used to request to execute a first resource transaction related to risk assessment; send a request for querying relevant authorization information of a risk assessment card corresponding to the first user to an authorization management platform 1020 that is connected to the blockchain, where the risk assessment card is used to authorize each resource trading platform to obtain risk assessment data corresponding to the first user; determine, based on the relevant authorization information, whether the first resource trading platform 1010 is authorized to obtain the risk assessment data of the first user, and if yes, obtain the risk assessment data of the first user from a blockchain node 1030; and determine, based on the risk assessment data of the first user, whether to execute the first resource transaction for the first user; the authorization management platform 1020 is configured to store relevant authorization information of a risk assessment card corresponding to each user; and query the relevant authorization information of the risk assessment corresponding to the first user based on the request for querying the relevant authorization information of the risk assessment card corresponding to the first user, where the request is sent by the first resource trading platform 1010; and the blockchain node 1030 is configured to store risk assessment data corresponding to each user; and send the risk assessment data to the first resource trading platform 1010 based on a request for obtaining the risk assessment data, where the request is sent by the first resource trading platform 1010.

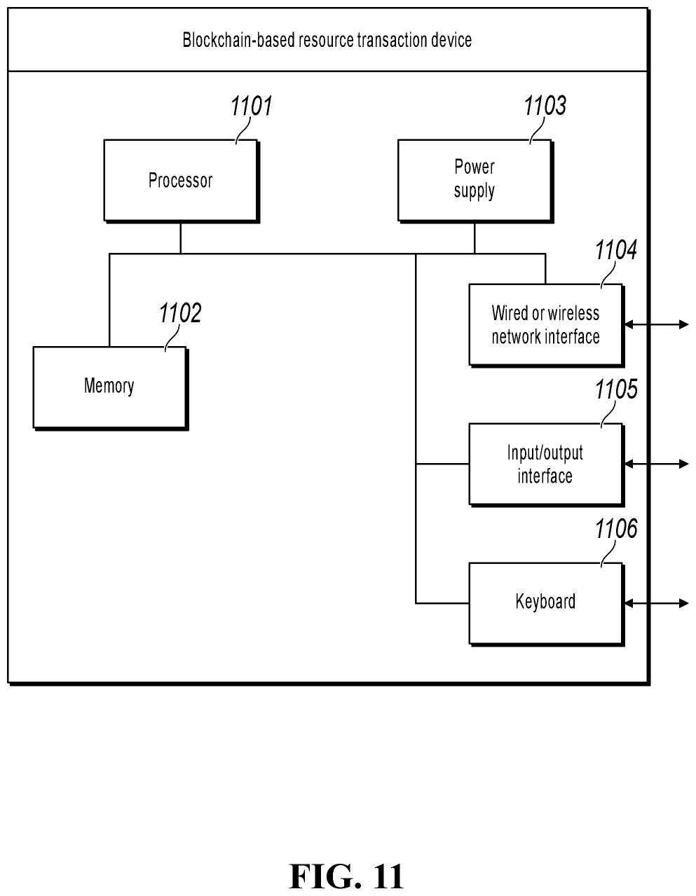

Based on the same idea, one or more embodiments of the present specification further provide an example of a blockchain-based resource device, as shown in FIG. 11. The blockchain-based resource device can differ greatly due to a difference in configuration or performance, and can include one or more processors 1101 and one or more memories 1102. The memory 1102 can store one or more applications or data. The memory 1102 can be a transitory storage or a non-transitory storage. The application program stored in the memory 1102 can include one or more modules (not shown in the figure), and each module can include a series of computer-executable instructions in the blockchain-based resource device. Still further, the processor 1101 can be configured to communicate with the memory 1102 to execute a series of computer-executable instructions in the memory 1102 on the blockchain-based resource device. The blockchain-based resource device can further include one or more power supplies 1103, one or more wired or wireless network interfaces 1104, one or more input/output interfaces 1105, one or more keypads 1106, etc.

Specifically, in these embodiments, the blockchain-based resource device includes a memory and one or more programs, where the one or more programs are stored in the memory, and the one or more programs can include one or more modules, and each module can include a series of computer-executable instructions in the blockchain-based resource device. The one or more processors are configured to execute the computer-executable instructions included in the one or more programs to perform the following operations: receiving a resource transaction request that is sent by a first user and that includes digital identity information of the first user, where the resource transaction request is used to request to execute a first resource transaction related to risk assessment; querying, based on the digital identity information, relevant authorization information of a risk assessment card corresponding to the first user from an authorization management platform that is connected to the blockchain, where the risk assessment card is used for a resource trading platform to obtain risk assessment data corresponding to the first user; determining, based on the relevant authorization information, whether the first resource trading platform is authorized to obtain the risk assessment data of the first user, and if yes, obtaining the risk assessment data of the first user from a blockchain node, where the blockchain node is used to store risk assessment data corresponding to each user; and determining, based on the risk assessment data of the first user, whether to execute the first resource transaction for the first user.

Specifically, in other embodiments, the blockchain-based resource device includes a memory and one or more programs, where the one or more programs are stored in the memory, and the one or more programs can include one or more modules, and each module can include a series of computer-executable instructions in the blockchain-based resource device. The one or more processors are configured to execute the computer-executable instructions included in the one or more programs to perform the following operations: obtaining risk assessment data of a first user, and obtaining digital identity information of the first user; uploading the digital identity information of the first user and the risk assessment data to a blockchain node, where the blockchain node is used to store the digital identity information of the first user and the risk assessment data in association, and send a blockchain storage certificate corresponding to the risk assessment data to the authorization management platform; and generating a risk assessment card corresponding to the first user based on the digital identity information of the first user and the blockchain storage certificate sent by the blockchain node, where the risk assessment card is used for a resource trading platform connected to the blockchain to obtain the risk assessment data from the blockchain node, and execute a related resource transaction for the first user based on the risk assessment data.

One or more embodiments of the present specification further provide a storage medium, where the storage medium stores one or more computer programs, and the one or more computer programs include instructions; when the instructions are executed by an electronic device that includes a plurality of applications, the electronic device is enabled to execute each process of the previous blockchain-based resource method embodiments, and can achieve the same technical effect. To avoid repetition, details are omitted herein.

The system, apparatus, module, or unit illustrated in the previous embodiments can be specifically implemented by using a computer chip or an entity, or can be implemented by using a product having a certain function. A typical implementation device is a computer. Specifically, for example, the computer can be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the previous apparatuses are described by dividing functions into various units. Certainly, during implementation of one or more embodiments of the present specification, the functions of each unit can be implemented in at least one of software or hardware.

A person skilled in the art should understand that one or more embodiments of the present specification can be provided as a method, a system, or a computer program product. Therefore, one or more embodiments of the present specification can use a form of hardware only embodiments, software only embodiments, or embodiments with a combination of software and hardware. In addition, one or more embodiments of the present specification can use a form of a computer program product that is implemented on one or more computer-usable storage media (including but not limited to a disk memory, a CD-ROM, an optical memory, etc.) that include computer-usable program code.

One or more embodiments of the present specification are described with reference to at least one of a flowchart or block diagram of the method, device (system), and computer program product according to the embodiments of the present application. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can alternatively be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer-readable medium does not include transitory media such as a modulated data signal and carrier.

It is worthwhile to further note that, the terms “include,” “comprise,” or any other variant thereof are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

One or more embodiments of the present specification can be described in the general context of computer-executable instructions, for example, a program module. Generally, the program module includes a routine, a program, an object, a component, a data structure, etc. executing a specific task or implementing a specific abstract data type. The present application can alternatively be practiced in distributed computing environments in which tasks are performed by remote processing devices that are connected through a communications network. In a distributed computing environment, the program module can be located in both local and remote computer storage media including storage devices.

The embodiments in the present specification are described in a progressive way. For same or similar parts of the embodiments, mutual references can be made to the embodiments. Each embodiment focuses on a difference from other embodiments.

Particularly, the system embodiments are briefly described because they substantially correspond to the method embodiments. For related parts, references can be made to related descriptions in the method embodiments.

The previous descriptions are merely one or more embodiments of the present specification, and are not intended to limit the present specification. A person skilled in the art can make various changes and variations to one or more embodiments of the present specification. Any modification, equivalent replacement, or improvement made without departing from the spirit and principle of one or more embodiments of the present specification shall fall within the scope of the claims in one or more embodiments of the present specification.

What is claimed is:

1. A computer-implemented method, comprising:
receiving, by a first resource trading platform connected to a blockchain network, a resource transaction request from a first user to execute a first resource transaction related to risk assessment, wherein the resource transaction request comprises digital identity information of the first user;
querying, based on the digital identity information, authorization information of a risk assessment card of the first user from an authorization management platform that is connected to the blockchain network;
determining, based on the authorization information, whether the first resource trading platform is authorized to obtain risk assessment data of the first user;
in response to determining that the first resource trading platform is authorized to obtain the risk assessment data of the first user, obtaining the risk assessment data of the first user from a blockchain node of the blockchain network; and
determining, based on the risk assessment data of the first user, whether to execute the first resource transaction for the first user.

2. The computer-implemented method of claim 1,
wherein querying, based on the digital identity information, the authorization information of the risk assessment card of the first user from the authorization management platform comprises querying a verifiable statement of the risk assessment card of the first user from the authorization management platform, wherein the verifiable statement comprises authorization information of one or more authorized resource trading platforms; and
wherein determining, based on the authorization information, whether the first resource trading platform is authorized to obtain the risk assessment data of the first user comprises:
determining whether the verifiable statement comprises first authorization information of the first resource trading platform; and
in response to determining that the verifiable statement comprises the first authorization information of the first resource trading platform, determining that the first resource trading platform is authorized to obtain the risk assessment data of the first user.

3. The computer-implemented method of claim 2, comprising:
in response to determining that the verifiable statement does not comprise the first authorization information of the first resource trading platform, providing the first user with an authorization portal for authorizing the first resource trading platform to obtain the risk assessment data of the first user; and
in response to receiving an authorization operation performed by the first user through the authorization portal, determining, based on the authorization operation, that the first resource trading platform is authorized to obtain the risk assessment data of the first user.

4. The computer-implemented method of claim 3, further comprising:
sending the first authorization information to the authorization management platform, wherein the first authorization information causes the authorization management platform to update the authorization information of the risk assessment card of the first user based on the first authorization information.

5. The computer-implemented method of claim 1, wherein the risk assessment data comprises a first risk assessment record of the first user, and wherein the first risk assessment record is used to record a first risk tolerance level obtained after risk assessment is performed on the first user; and
wherein determining, based on the risk assessment data of the first user, whether to execute the first resource transaction for the first user comprises:
determining, based on the first risk assessment record, whether the first risk tolerance level corresponding to the first user meets a transaction level requirement corresponding to the first resource transaction;
sending a determination result of whether the first risk tolerance level meets the transaction level requirement to the first user;
in response to determining that the first risk tolerance level corresponding to the first user meets the transaction level requirement corresponding to the first resource transaction, executing the first resource transaction for the first user; and
sending a resource transaction result corresponding to the first resource transaction to the first user.

6. The computer-implemented method of claim 5, wherein the risk assessment data further comprises risk profile data of the first user; the method further comprising:
in response to demining that the first risk tolerance level corresponding to the first user does not meet the transaction level requirement corresponding to the first resource transaction, sending the risk profile data to the first user when an assessment request of the first user to re-assesse a risk tolerance level is received;
when an updating operation of the first user for the risk profile data is received, updating the risk profile data based on the updating operation;
obtain a second risk tolerance level corresponding to the first user by re-assessing the risk tolerance level of the first user based on updated risk profile data; and
determining, based on the second risk tolerance level, whether to execute the first resource transaction for the first user.

7. The computer-implemented method of claim 6, comprising:
updating, based on the second risk tolerance level, the first risk assessment record corresponding to the first user stored in the blockchain node.

8. The computer-implemented method of claim 1, comprising:
obtaining a query result corresponding to a second risk assessment record by querying the second risk assessment record corresponding to the first user from the first resource trading platform,
wherein querying the authorization information of the risk assessment card of the first user from the authorization management platform that is connected to the blockchain network comprises in response to determining that the query result is a predetermined type of query result, querying the authorization information of the risk assessment card of the first user from the authorization management platform that is connected to the blockchain network,
wherein the predetermined type of query result comprises at least one of the following: the second risk assessment record is not identified in the first resource trading platform, or a third risk tolerance level corresponding to the first user recorded in the second risk assessment record does not meet transaction level requirement corresponding to the first resource transaction.

9. A non-transitory, computer-readable medium storing one or more instructions executable by a computer system to perform operations comprising:
receiving, by a first resource trading platform connected to a blockchain network, a resource transaction request from a first user to execute a first resource transaction related to risk assessment, wherein the resource transaction request comprises digital identity information of the first user;
querying, based on the digital identity information, authorization information of a risk assessment card of the first user from an authorization management platform that is connected to the blockchain network;
determining, based on the authorization information, whether the first resource trading platform is authorized to obtain risk assessment data of the first user;
in response to determining that the first resource trading platform is authorized to obtain the risk assessment data of the first user, obtaining the risk assessment data of the first user from a blockchain node of the blockchain network; and
determining, based on the risk assessment data of the first user, whether to execute the first resource transaction for the first user.

10. The non-transitory, computer-readable medium of claim 9,
wherein querying, based on the digital identity information, the authorization information of the risk assessment card of the first user from the authorization management platform comprises querying a verifiable statement of the risk assessment card of the first user from the authorization management platform, wherein the verifiable statement comprises authorization information of one or more authorized resource trading platforms; and
wherein determining, based on the authorization information, whether the first resource trading platform is authorized to obtain the risk assessment data of the first user comprises:
determining whether the verifiable statement comprises first authorization information of the first resource trading platform; and
in response to determining that the verifiable statement comprises the first authorization information of the first resource trading platform, determining that the first resource trading platform is authorized to obtain the risk assessment data of the first user.

11. The non-transitory, computer-readable medium of claim 10, wherein the operations further comprise:
in response to determining that the verifiable statement does not comprise the first authorization information of the first resource trading platform, providing the first user with an authorization portal for authorizing the first resource trading platform to obtain the risk assessment data of the first user; and
in response to receiving an authorization operation performed by the first user through the authorization portal, determining, based on the authorization operation, that the first resource trading platform is authorized to obtain the risk assessment data of the first user.

12. The non-transitory, computer-readable medium of claim 11, wherein the operations further comprise:
sending the first authorization information to the authorization management platform, wherein the first authorization information causes the authorization management platform to update the authorization information of the risk assessment card of the first user based on the first authorization information.

13. The non-transitory, computer-readable medium of claim 9, wherein the risk assessment data comprises a first risk assessment record of the first user, and wherein the first risk assessment record is used to record a first risk tolerance level obtained after risk assessment is performed on the first user; and
wherein determining, based on the risk assessment data of the first user, whether to execute the first resource transaction for the first user comprises:
determining, based on the first risk assessment record, whether the first risk tolerance level corresponding to the first user meets a transaction level requirement corresponding to the first resource transaction;
sending a determination result of whether the first risk tolerance level meets the transaction level requirement to the first user;
in response to determining that the first risk tolerance level corresponding to the first user meets the transaction level requirement corresponding to the first resource transaction, executing the first resource transaction for the first user; and
sending a resource transaction result corresponding to the first resource transaction to the first user.

14. The non-transitory, computer-readable medium of claim 13, wherein the risk assessment data further comprises risk profile data of the first user, wherein the operations further comprise:
in response to demining that the first risk tolerance level corresponding to the first user does not meet the transaction level requirement corresponding to the first resource transaction, sending the risk profile data to the first user when an assessment request of the first user to re-assesse a risk tolerance level is received;
when an updating operation of the first user for the risk profile data is received, updating the risk profile data based on the updating operation;
obtain a second risk tolerance level corresponding to the first user by re-assessing the risk tolerance level of the first user based on updated risk profile data; and
determining, based on the second risk tolerance level, whether to execute the first resource transaction for the first user.

15. The non-transitory, computer-readable medium of claim 14, wherein the operations further comprise:
updating, based on the second risk tolerance level, the first risk assessment record corresponding to the first user stored in the blockchain node.

16. The non-transitory, computer-readable medium of claim 9, wherein the operations further comprise:
obtaining a query result corresponding to a second risk assessment record by querying the second risk assessment record corresponding to the first user from the first resource trading platform,
wherein querying the authorization information of the risk assessment card of the first user from the authorization management platform that is connected to the blockchain network comprises in response to determining that the query result is a predetermined type of query result, querying the authorization information of the risk assessment card of the first user from the authorization management platform that is connected to the blockchain network,
wherein the predetermined type of query result comprises at least one of the following: the second risk assessment record is not identified in the first resource trading platform, or a third risk tolerance level corresponding to the first user recorded in the second risk assessment record does not meet transaction level requirement corresponding to the first resource transaction.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a first resource trading platform connected to a blockchain network, a resource transaction request from a first user to execute a first resource transaction related to risk assessment, wherein the resource transaction request comprises digital identity information of the first user;
querying, based on the digital identity information, authorization information of a risk assessment card of the first user from an authorization management platform that is connected to the blockchain network;
determining, based on the authorization information, whether the first resource trading platform is authorized to obtain risk assessment data of the first user;
in response to determining that the first resource trading platform is authorized to obtain the risk assessment data of the first user, obtaining the risk assessment data of the first user from a blockchain node of the blockchain network; and
determining, based on the risk assessment data of the first user, whether to execute the first resource transaction for the first user.

18. The computer-implemented system of claim 17,
wherein querying, based on the digital identity information, the authorization information of the risk assessment card of the first user from the authorization management platform comprises querying a verifiable statement of the risk assessment card of the first user from the authorization management platform, wherein the verifiable statement comprises authorization information of one or more authorized resource trading platforms; and
wherein determining, based on the authorization information, whether the first resource trading platform is authorized to obtain the risk assessment data of the first user comprises:
determining whether the verifiable statement comprises first authorization information of the first resource trading platform; and
in response to determining that the verifiable statement comprises the first authorization information of the first resource trading platform, determining that the first resource trading platform is authorized to obtain the risk assessment data of the first user.

19. The computer-implemented system of claim 18, wherein the one or more operations further comprise:
in response to determining that the verifiable statement does not comprise the first authorization information of the first resource trading platform, providing the first user with an authorization portal for authorizing the first resource trading platform to obtain the risk assessment data of the first user; and
in response to receiving an authorization operation performed by the first user through the authorization portal, determining, based on the authorization operation, that the first resource trading platform is authorized to obtain the risk assessment data of the first user.

20. The computer-implemented system of claim 19, wherein the one or more operations further comprise:
sending the first authorization information to the authorization management platform, wherein the first authorization information causes the authorization management platform to update the authorization information of the risk assessment card of the first user based on the first authorization information.
